(19) United States
(12) Patent Application Publication
(10) Pub. No.: US 2026/0274753 A1
(43) Pub. Date: Sep. 17, 2026

(54) CERAMIC AND METAL MATERIALS WITH CONTROLLED MICROSTRUCTURES, AND SYSTEMS AND METHODS FOR FABRICATION AND USE THEREOF

(71) Applicant: UNIVERSITY OF MARYLAND, COLLEGE PARK, College Park, MD (US)

(72) Inventors: Liangbing HU, Woodbridge, CT (US); Hua XIE, Hyattsville, MD (US); Shufeng LIU, College Park, MD (US)

(21) Appl. No.: 19/471,979

(22) PCT Filed: Apr. 19, 2024
(86) PCT No.: PCT/US2024/025591

§ 371 Date: Oct. 2, 2025

Related U.S. Application Data
(60) Provisional application No. 63/461,057, filed on Apr. 21, 2023.

(51) Int. Cl. C04B 35/488; H01M 10/0562; H01M 50/403; H01M 50/434

(52) U.S. Cl. CPC C04B 35/488; H01M 10/0562; H01M 50/403; H01M 50/434; C04B 2235/3203; C04B 2235/3227; C04B 2235/3246; C04B 2235/764; H01M 2300/0077

(57) ABSTRACT

The microstructure of metallic and/or ceramic layers is controlled based on heating/cooling parameters of the fabrication process. The heating/cooling parameters can be selected to generate materials completely in the glass phase, having a hybrid construction (e.g., glass/crystalline) with different lattice microstructures, or having a polycrystalline microstructure with aligned crystal grains. Such materials with controlled microstructures can be used as solid-state electrolytes (SSEs), as cathodes in solid-state batteries, or as structural materials. When employed as SSEs, the glass phase portions of the fabricated materials can function as an interphase layer that blocks ion penetration and/or dendrite formation, while still retaining good ionic conductivity.

### CROSS-REFERENCE TO RELATED APPLICATIONS

The present application claims the benefit of and priority to U.S. Provisional Application No. 63/461,057, filed Apr. 21, 2023, entitled “Ceramic and Metal Materials with Controlled Microstructures, and Systems and Methods for Fabrication and Use Thereof,” which is hereby incorporated by reference herein in its entirety.

### FIELD

The present disclosure relates generally to ceramic and metal materials, and more particularly, to fabrication of ceramic and metal materials with controlled microstructures.

### SUMMARY

Embodiments of the disclosed subject matter provide metallic and/or ceramic layers having microstructures that can be controlled based on heating/cooling parameters of the fabrication process. In some embodiments, the heating/cooling parameters can be selected to generate films, membranes, or layers completely in the glass phase or having a hybrid construction (e.g., glass/crystalline) with different lattice microstructures. Alternatively or additionally, in some embodiments, the heating/cooling parameters can be selected to generate polycrystalline films, membranes, or layers with aligned crystal grains. For example, the fabricated materials with controlled microstructures can be employed as solid-state electrolytes (SSEs) (e.g., exhibiting high current density tolerance), as a cathode in a solid-state battery, and/or as structural materials (e.g., with high mechanical properties). For example, when employed as SSEs, the glass phase portions of the fabricated materials can function as an interphase layer that blocks dendrite formation, while still retaining good ionic conductivity (e.g., an ion conductivity of at least 10⁻⁴ S/cm).

In one or more embodiments, a structure can comprise a solid-state ion-conducting layer. In some embodiments, at least a portion of the ion-conducting layer is in a glass phase. In some embodiments, an entirety of the solid-state ion-conducting layer may be in the glass phase. Alternatively, in some embodiments, the solid-state ion-conducting layer can have a microstructure with one or more crystalline portions (e.g., islands) within and surrounded by the glass phase (e.g., glass sea). Alternatively, in some embodiments, the solid-state ion-conducting layer can have a microstructure with a polycrystalline sublayer sandwiched between opposing glass phase sublayers. Alternatively, in some embodiments, the solid-state ion-conducting layer can have a microstructure with a glass phase sublayer on a polycrystalline sublayer. Alternatively, in some embodiments, the solid-state ion-conducting layer can comprise a polycrystalline ceramic having crystal grains substantially aligned with respect to a common direction. In some embodiments, the solid-state ion-conducting layer can be employed as a solid-state electrolyte in a battery (e.g., solid-state battery).

In one or more embodiments, a method can comprise subjecting a first material to a heating period, and, after the subjecting, cooling the heated first material to form a structure with a controlled microstructure. At least a portion of the formed structure can be in a glass phase, or the formed structure can comprise a polycrystalline ceramic having crystal grains substantially aligned with respect to a common direction.

In one or more embodiments, a cathode layer can comprise a positive electrode material, and one of: (i) a non-oxide solid electrolyte and (ii) beta-alumina, glassy sodium polyaluminate, or both. In some embodiments, the cathode layer can be employed as a cathode in a battery (e.g., solid-state battery).

Any of the various innovations of this disclosure can be used in combination or separately. This summary is provided to introduce a selection of concepts in a simplified form that are further described below in the detailed description. This summary is not intended to identify key features or essential features of the claimed subject matter, nor is it intended to be used to limit the scope of the claimed subject matter. The foregoing and other objects, features, and advantages of the disclosed technology will become more apparent from the following detailed description, which proceeds with reference to the accompanying figures.

### BRIEF DESCRIPTION OF THE DRAWINGS

Embodiments will hereinafter be described with reference to the accompanying drawings, which have not necessarily been drawn to scale. Where applicable, some elements may be simplified or otherwise not illustrated in order to assist in the illustration and description of underlying features. Throughout the figures, like reference numerals denote like elements.

FIG. 1A is a process flow diagram of a method for forming ceramic or metal materials with controlled microstructures, according to one or more embodiments of the disclosed subject matter.

FIG. 1B is a simplified schematic diagram of a heating and cooling setups for controlling microstructures of ceramic or metal materials, according to one or more embodiments of the disclosed subject matter.

FIG. 1C is a graph comparing temperature profiles for fabricating ceramic or metal materials, according to one or more embodiments of the disclosed subject matter.

FIG. 2A are simplified schematic diagrams of different microstructure configurations for ceramic or metal materials, according to one or more embodiments of the disclosed subject matter.

FIG. 2B is a simplified schematic diagram illustrating conversion of a crystalline structure to a glassy structure, according to one or more embodiments of the disclosed subject matter.

FIG. 3A is a process flow diagram of another method for forming ceramic or metal polycrystalline materials with controlled microstructure, according to one or more embodiments of the disclosed subject matter.

FIGS. 3B-3C are simplified schematic diagrams illustrating aspects of a heating setup for applying a thermal gradient to control microstructures of ceramic or metal materials, according to one or more embodiments of the disclosed subject matter.

FIG. 4 is a simplified schematic diagram of a microstructure configuration for a ceramic or metal material having aligned, needle-like grains, according to one or more embodiments of the disclosed subject matter.

FIG. 5A is a simplified schematic diagram of a solid-state battery employing one or more layers with controlled microstructure, according to one or more embodiments of the disclosed subject matter.

FIG. 5B illustrates a polycrystalline microstructure of a conventional solid-state electrolyte before and after cycling.

FIG. 5C illustrates an island-in-the-sea microstructure of a solid-state electrolyte before and after cycling, according to one or more embodiments of the disclosed subject matter.

FIG. 5D illustrates a glass-polycrystalline-glass sandwich microstructure of a solid-state electrolyte before and after cycling, according to one or more embodiments of the disclosed subject matter.

FIG. 5E illustrates a glass-polycrystalline bilayer microstructure of a solid-state electrolyte before and after cycling, according to one or more embodiments of the disclosed subject matter.

FIG. 6 depicts a generalized example of a computing environment in which the disclosed technologies may be implemented.

FIG. 7A is a graph of powder X-ray diffraction (XRD) results for glassy lithium lanthanum zirconium oxide (LLZO), showing no defined peak.

FIG. 7B shows a high-angle annular dark-field (HAADF) scanning transmission electron microscopy (STEM) image of glassy LLZO, with a Fast Fourier Transform (FFT) of the STEM image in the inset, showing amorphous structure.

FIG. 7C shows a band-pass-filtered STEM image illustrating the atomistic arrangements of glassy LLZO.

FIG. 8A a photograph of an island-in-the-sea (ITS) LLZO electrolyte.

FIG. 8B is a scanning electron microscopy (SEM) image of a cracked cross-section of the ITS LLZO electrolyte of FIG. 8A, in which the Wallner lines, common to glass materials, can be seen.

FIG. 8C is an SEM image of an Ar-polished cross-section of the ITS LLZO electrolyte of FIG. 8A, in which the grains can be seen as islands embedded in a glass layer.

FIG. 8D shows high-resolution transmission electron microscopy (TEM) of the interface between glass and crystalline LLZO grains (top), atomic-resolution STEM images of the crystalline LLZO islands (right), and atomic-resolution STEM images of the glass LLZO regions (left).

FIG. 9A is a simplified schematic diagram of a chronoamperometry measurement to determine electronic conductivity of the electrolyte.

FIG. 9B is a graph showing the measured chronoamperometry profile of crystalline garnet-type LLZO electrolyte (blue curve) and glass LLZO electrolyte (orange curve), where the steady-state current for each is calculated to be 2.0×10⁻⁷ A and 1.0×10⁻⁸ A, respectively (where the electronic conductivity of the glass electrolyte reached the limit of the employed potentiostat, which has minimum signal value of 1.00×10⁻⁸ A).

FIG. 9C is a simplified schematic of a symmetric cell for critical current density (CCD) measurements, as well as SEM images showing good Li metal-glass electrolyte interface after an ALD-ZnO₂ surface modification of the electrolyte.

FIG. 9D is a graph showing CCD voltage profile of the glass LLZO electrolyte, in which the electrolyte can sustain a current limit of 16 mA/cm² , where the stripping and plating time for each cycle was 4 hours.

FIG. 9E is a graph of cumulative areal capacity comparing performance of the glass electrolyte fabricated according to embodiments of the disclosed subject matter to conventionally fabricated electrolytes such as LiPON.

FIG. 10 are photographs illustrating the liquification transition of LLZO crystalline electrolyte above 1400° C.

FIG. 11A is an SEM image of one of the interfaces for an alumina sandwich structure (e.g., beta-alumina region between glassy sodium polyaluminate regions).

FIGS. 11B-11C are SEM images of the glassy sodium polyaluminate region and the beta-alumina region, respectively, from the alumina sandwich structure of FIG. 11A.

FIGS. 11D-11E show XRD patterns for pure crystalline beta alumina and alumina sandwich structure, respectively, where the peaks show the crystallinity evolution of the different structures.

FIGS. 11F-11G show scanning transmission electron microscopy (STEM) images of amorphous and crystalline phases, respectively, in the alumina sandwich structure of FIG. 11A. FIG. 12A is a simplified schematic diagram of an anode-free battery configuration, according to one or more embodiments of the disclosed subject matter.

FIG. 12B is a simplified schematic diagram of a bilayer structure for a battery, where the electrolyte can be LLZO having one of the disclosed microstructures, and the cathode can include a porous support (e.g., Nb₂O₅, yttria-stabilized zirconia (YSZ), or lanthanum strontium manganite (LSM)), according to one or more embodiments of the disclosed subject matter.

FIG. 12C is an SEM image of a fabricated bilayer having an ITS LLZO layer on a porous YSZ substrate according to the structure of FIG. 12B.

FIG. 12D is an SEM image of a fabricated bilayer having an ITS LLZO layer on a porous LSM substrate, according to the structure of FIG. 12B.

FIG. 12E is a simplified schematic diagram of another bilayer structure for a battery, where the electrolyte can be alumina having one of the disclosed microstructures, and the cathode can include a porous support (e.g., YSZ), according to one or more embodiments of the disclosed subject matter.

FIG. 13A is a simplified schematic diagram of a battery configuration with a composite cathode, according to one or more embodiments of the disclosed subject matter.

FIG. 13B is a simplified schematic diagram of an all solid-state Na metal battery structure, where the anode can be Na metal or Na-Sn alloy (Sn ratio: 20-80 wt %), the electrolyte can be glassy sodium polyaluminate having one of the disclosed microstructures, and the cathode can be-alumina co-sintered cathode (e.g., Na_{0.66}Ni_{0.33}Mn_{0.67}O₂ or Na₃V₂(PO₄)₃ (NVP)), according to one or more embodiments of the disclosed subject matter.

FIG. 13C is a simplified schematic diagram of all solid-state Na metal battery structure, where the anode can be Na metal or Na-Sn alloy (Sn ratio: 20-80 wt %), the electrolyte can be glassy sodium polyaluminate having one of the disclosed microstructures, and the cathode can be non-oxide SSE/carbon hot pressed with cathode materials (e.g., Na_{0.66}Ni_{0.33}Mn_{0.67}O₂ or Na₃V₂(PO₄)₃), according to one or more embodiments of the disclosed subject matter.

FIGS. 14A-14B are cross-sectional SEM and STEM images, respectively of a nickel manganese cobalt (NMC) and LLZO interface in a co-sintered cathode.

FIG. 15A is a simplified schematic diagram of an all solid-state full cell, where the anode can be Li metal, the electrolyte can be an LLZO membrane having one of the disclosed microstructures, and the cathode can comprise a non-oxide halide solid electrolyte or sulfide solid electrolyte (e.g., Li₆PS₅Cl (LPSCl)), carbon additive (e.g., carbon black), and/or NMC, according to one or more embodiments of the disclosed subject matter.

FIG. 15B shows electrochemical impedance spectroscopy (EIS) results from 7 MHz to 100 mHz at 60° C., for an all solid-state cell having the structure of FIG. 15A and a cathode thickness of 150 μm.

FIG. 15C shows voltage-capacity curves of the first five charge-discharge cycles at 60° C. and a charge/discharge rate of 0.1 C, for the all solid-state cell having the structure of FIG. 15A.

FIG. 15D is a simplified schematic diagram of an all solid-state full cell, where the anode can be Li metal, the electrolyte can be an LLZO membrane having one of the disclosed microstructures, and the cathode can comprise a non-oxide halide solid state electrolyte, carbon additive (e.g., carbon black), and/or NMC, according to one or more embodiments of the disclosed subject matter.

FIG. 15E is a simplified schematic diagram of an all solid-state full cell, where the anode can be a sodium alloy composite (e.g., Na—Sn alloy), the electrolyte can be alumina having one of the disclosed microstructures, and the cathode can comprise a non-oxide solid state electrolyte (e.g., Na—Sn—P—S), carbon additive (e.g., carbon black), and/or Na—Mn—Fe—Ni—O, according to one or more embodiments of the disclosed subject matter.

FIG. 15F is a simplified schematic diagram of an all solid-state full cell, where the anode can be a sodium alloy composite (e.g., Na—Sn alloy), the electrolyte can be alumina having one of the disclosed microstructures, and the cathode can be non-oxide solid state electrolyte (e.g., Na—Y—Zr—Cl), carbon additive (e.g., carbon black), and/or Na—Mn—Fe—Ni—O, according to one or more embodiments of the disclosed subject matter.

FIG. 16A is a graph of EIS results for an Li-ITS LLZO-Li symmetric battery cell.

FIG. 16B is a graph of critical current density measurements of the ITS LLZO electrolyte, in which the electrolyte can be stable at 16 mA/cm², with Li plating/strip period of 4 hours.

FIG. 16C is a graph of galvanostatic cycling of the Li-ITS LLZO-Li symmetric battery cell at room temperature and a current density of 10mA/cm².

FIG. 16D is a graph of EIS results of an Na-sandwiched alumina-Na symmetric battery cell.

FIG. 16E is a graph of critical current density measurements of the sandwiched alumina electrolyte, in which the electrolyte can be stable at 8.5mA/cm², with Li plating/strip period of 0.5 hours.

FIG. 16F is a graph of galvanostatic cycling of the Na-sandwiched alumina-Na symmetric battery cell at room temperature and various current densities.

FIG. 17A shows SEM images of cross-sections of textured beta-alumina, with aligned grains formed via an applied thermal gradient during sintering.

FIG. 17B shows STEM images of atomic structure of the textured beta-alumina of FIG. 17A, illustrating the direction of Na conducting planes being the same as the grain growth.

FIG. 17C shows EIS results of an Na-textured beta-alumina-Na symmetric battery cell.

### DETAILED DESCRIPTION

### General Considerations

For purposes of this description, certain aspects, advantages, and novel features of the embodiments of this disclosure are described herein. The disclosed methods and systems should not be construed as being limiting in any way. Instead, the present disclosure is directed toward all novel and nonobvious features and aspects of the various disclosed embodiments, alone and in various combinations and sub-combinations with one another. The methods and systems are not limited to any specific aspect or feature or combination thereof, nor do the disclosed embodiments require that any one or more specific advantages be present, or problems be solved. The technologies from any embodiment or example can be combined with the technologies described in any one or more of the other embodiments or examples. In view of the many possible embodiments to which the principles of the disclosed technology may be applied, it should be recognized that the illustrated embodiments are exemplary only and should not be taken as limiting the scope of the disclosed technology.

Although the operations of some of the disclosed methods are described in a particular, sequential order for convenient presentation, it should be understood that this manner of description encompasses rearrangement, unless a particular ordering is required by specific language set forth below. For example, operations described sequentially may in some cases be rearranged or performed concurrently. Moreover, for the sake of simplicity, the attached figures may not show the various ways in which the disclosed methods can be used in conjunction with other methods. Additionally, the description sometimes uses terms like “provide” or “achieve” to describe the disclosed methods. These terms are high-level abstractions of the actual operations that are performed. The actual operations that correspond to these terms may vary depending on the particular implementation and are readily discernible by one skilled in the art.

The disclosure of numerical ranges should be understood as referring to each discrete point within the range, inclusive of endpoints, unless otherwise noted. Unless otherwise indicated, all numbers expressing quantities of components, molecular weights, percentages, temperatures, times, and so forth, as used in the specification or claims are to be understood as being modified by the term “about.” Accordingly, unless otherwise implicitly or explicitly indicated, or unless the context is properly understood by a person skilled in the art to have a more definitive construction, the numerical parameters set forth are approximations that may depend on the desired properties sought and/or limits of detection under standard test conditions/methods, as known to those skilled in the art. When directly and explicitly distinguishing embodiments from discussed prior art, the embodiment numbers are not approximates unless the word “about,” “substantially,” or “approximately” is recited. Whenever “substantially,” “approximately,” “about,” or similar language is explicitly used in combination with a specific value, variations up to and including 10% of that value are intended, unless explicitly stated otherwise.

Directions and other relative references may be used to facilitate discussion of the drawings and principles herein but are not intended to be limiting. For example, certain terms may be used such as “inner,” “outer,” “upper,” “lower,” “top,” “bottom,” “interior,” “exterior,” “left,” right,” “front,” “back,” “rear,” and the like. Such terms are used, where applicable, to provide some clarity of description when dealing with relative relationships, particularly with respect to the illustrated embodiments. Such terms are not, however, intended to imply absolute relationships, positions, and/or orientations. For example, with respect to an object, an “upper” part can become a “lower” part simply by turning the object over. Nevertheless, it is still the same part, and the object remains the same.

As used herein, “comprising” means “including,” and the singular forms “a” or “an” or “the” include plural references unless the context clearly dictates otherwise. The term “or” refers to a single element of stated alternative elements or a combination of two or more elements unless the context clearly indicates otherwise.

Although there are alternatives for various components, parameters, operating conditions, etc. set forth herein, that does not mean that those alternatives are necessarily equivalent and/or perform equally well. Nor does it mean that the alternatives are listed in a preferred order, unless stated otherwise. Unless stated otherwise, any of the groups defined below can be substituted or unsubstituted.

Unless explained otherwise, all technical and scientific terms used herein have the same meaning as commonly understood to one skilled in the art to which this disclosure belongs.

Although methods and materials similar or equivalent to those described herein can be used in the practice or testing of the present disclosure, suitable methods and materials are described below. The materials, methods, and examples are illustrative only and not intended to be limiting. Features of the presently disclosed subject matter will be apparent from the following detailed description and the appended claims.

### Overview of Terms

The following is provided to facilitate the description of various aspects of the disclosed subject matter and to guide those skilled in the art in the practice of the disclosed subject matter.

High-temperature Heating Period: Application of a sintering temperature for a limited time period after which the heated (e.g., sintered) material is rapidly cooled. In some embodiments, the duration of the heating period is less than 5 minutes, for example, less than or equal to about 60 seconds. In some embodiments, the duration of the time period of heating is less than 30 seconds, for example, in a range of 5-20 seconds (e.g., 3-10 second. In some embodiments, heating to the sintering temperature prior to the actual heating period may be at a ramp rate of at least 10²° C./s (e.g., about 10²-10⁵° C./s), and/or cooling from the sintering temperature at a ramp rate of at least 10²° C./s (e.g., about 10²-10⁵° C./s).

Sintering temperature: A peak or maximum temperature at a surface of one or more heating elements when energized (e.g., by application of a current pulse) and/or at a surface of a material being sintered (e.g., bulk pellet or powder). In some embodiments, the sintering temperature is at least about 725° C. (~1000 K), for example, at least 1225° C. (~1500 K). In some embodiments, the sintering temperature is in a range of about 1225° C. (~1500 K) to about 2725° C. (~3000 K), inclusive. In some embodiments, the sintering temperature is greater than a melting temperature (T_{M}) of the material being sintered, for example, within one of a first range (e.g., T₁>T_{M}+100° C., such as T₁≈T_{M}+200° C.), a second range less than the first range (e.g., T_{M}+50° C.≤T₂≤T_{M}+100° C.), and a third range (e.g., T_{M}<T₃<T_{M}+50° C.) less than the second range, depending on a desired microstructure. Alternatively, in some embodiments, the sintering temperature is less than the melting temperature of the material being sintered, for example, when the sintered material does not include a glassy portion (e.g., textured ceramic). In some embodiments, the sintering temperature is a maximum temperature experienced by a material being sintered (e.g., bulk pellet or powder). In some embodiments, a temperature at the material being sintered can match or substantially match (e.g., within 10%) the temperature of at least one heating element.

Glass phase: In a ceramic and/or metal material, a disordered atomic-scale structure, e.g., amorphous or substantially amorphous (e.g., without long-range order or periodicity in atomic arrangement) as opposed to crystalline. In some embodiments, the glass phase material may exhibit only short-range order (e.g., order over no more than two atom spacings). Alternatively, in some embodiments, the glass phase material can have one or more portions with medium-range order (e.g., in a range of 0.5-5 nm, inclusive) but without exhibiting long-range order across the material.

Grain: In a crystalline solid, a region of multiple particles having an uninterrupted crystal structure. The interface between two grains in the crystalline solid forms a grain boundary.

Grain size: A cross-sectional dimension (e.g., diameter) of crystals within a crystalline solid (e.g., a sintered material, such as an ionic conductor). In some embodiments, an identified ‘grain size represents an average size for all grains (e.g., an average of the maximum cross-sectional dimensions). In some embodiments, the grain size can be measured according to one or more known standards, such as, but not limited to, ASTM E112-13, entitled “Standard Test Methods for Determining Average Grain Size” and published Nov. 17, 2021, and ISO 643:2019, entitled “Steels—Micrographic Determination of the Apparent Grain Size” and published March 2020, all of which are incorporated by reference herein.

NASICON: Sodium-based super ionic conductors, for example, having a chemical formula of Na₁₊ₓZr₂SiₓP₃₋ₓO₁₂, where 0<x<3. In some embodiments, Zr, Si, and/or Na in the chemical formula can be replaced by an isovalent element, such as V, Sb, or Ta.

LISICON: Lithium-based super ionic conductor, for example, having a chemical formula of Li₂₊₂ₓZn₁₋ₓGeO₄.

Beta-alumina: A polycrystalline ceramic formed of alumina with sodium in its crystal structure. References to β-alumina herein may include the β-structure (e.g., having a hexagonal symmetry and having a unit cell formed by two spinal blocks) as well as the β″-structure (e.g., having a rhombohedral symmetry and having a unit cell formed by three spinal blocks).

Glassy sodium polyaluminate: Alumina with sodium in the glass phase that has been generated from subjecting β-alumina to a high-temperature heating period and subsequent quenching. In some embodiments, the glassy sodium polyaluminate is derived from β″-alumina, which may exhibit a higher ionic conductivity than β-alumina.

Textured ceramic: A polycrystalline ceramic (e.g., beta-alumina) having crystal grains substantially aligned along a common direction. In some embodiments, the direction of grain alignment can be based on a direction of a thermal gradient applied during formation (e.g., sintering) of the textured ceramic. In some embodiments, most (e.g., >75%) or substantially all of the crystal grains in the textured ceramic have a needle-like configuration.

### Introduction

Embodiments of the disclosed subject matter system provide metallic and/or ceramic layers having microstructures that can be selected based on heating/cooling parameters of the fabrication process, for example, to generate films, membranes, or layers completely in the glass phase, having a hybrid construction (e.g., glass/crystalline) with different lattice microstructures, or having aligned crystal grains (e.g., needle-like grains). In some embodiments, the sintering temperature and/or the cooling rate are actively controlled to select between an all glass microstructure, an island-in-the-sea (ITS) microstructure (e.g., where crystalline islands are embedded within a glass sea), a glass-crystalline-glass layered sandwich microstructure, and a glass-crystalline bi-layer microstructure, for the same material composition. Alternatively or additionally, in some embodiments, a thermal gradient can be applied (e.g., by applying different powers to Joule heaters on opposite sides of a precursor materials during sintering) to select for a textured polycrystalline microstructure (e.g., where needle-like grains are substantially aligned along a common direction).

In some embodiments, the fabricated materials can be employed as solid-state electrolytes (SSEs) (e.g., exhibiting high current density tolerance), as a cathode in a solid-state battery, and/or as structural materials (e.g., with high mechanical properties). In some embodiments, the glass phase portion of the fabricated SSE can function as an interphase layer that helps block ion penetration (e.g., Li or Na metal ions) and subsequent dendrite formation, while still offering high ion conductivity (e.g., at least 10⁻⁴ S/cm). For example, in some embodiments, any crystalline domains within the fabricated SSE do not form a percolating pathway, i.e., such that the interfaces among the crystalline domains do not form a continuous path through a thickness of the SSE. Alternatively or additionally, the textured polycrystalline microstructure can provide shorter ion transport distances, which can offer higher ion conductivity (e.g., ≥4 mS/cm) than conventional polycrystalline electrolyte materials.

### Microstructure Control Methods and Systems

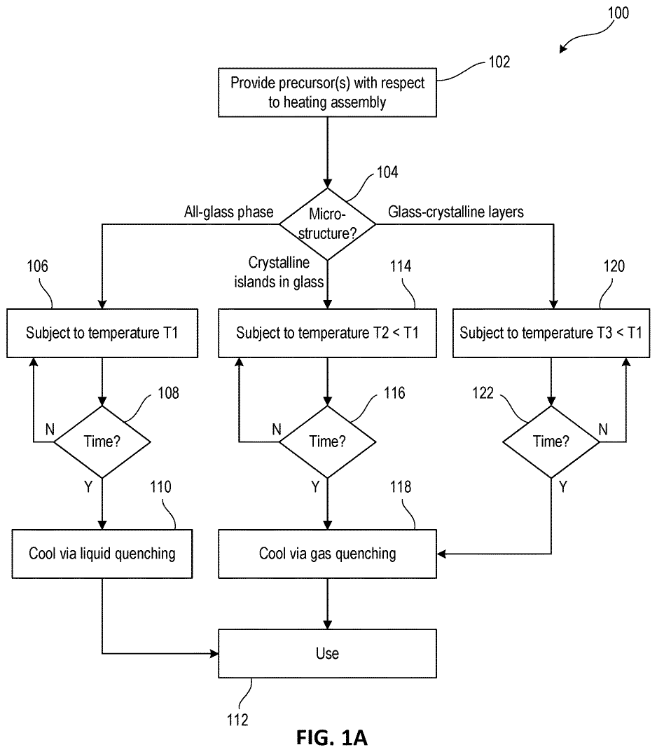

FIG. 1A shows a method 100 for fabricating a material (e.g., a bulk pellet, layer, film or other structure formed of ceramic and/or metal) with a microstructure controlled between fully glassy and hybrid glassy-crystalline (e.g., island-in-the-sea (ITS), sandwiched glass-polycrystalline-glass, or bi-layer glass-polycrystalline). In some embodiments, the method 100 can select the microstructure for the fabricated material without having to alter the composition of the material (e.g., the same material composition can yield a fully glassy microstructure or a hybrid glassy-crystalline microstructure simply by changing the fabrication process conditions).

The method 100 can initiate at process block 102, where a precursor material can be provided with respect to a heating assembly. In some embodiments, the precursor material can comprise one or more precursors, for example, to be sintered and/or react together to form one or more layers. Alternatively or additionally, in some embodiments, the precursor material can comprise a pre-fabricated polycrystalline or single-crystal member, for example, a crystalline membrane to be converted to fully glassy or a hybrid glassy-crystalline microstructure.

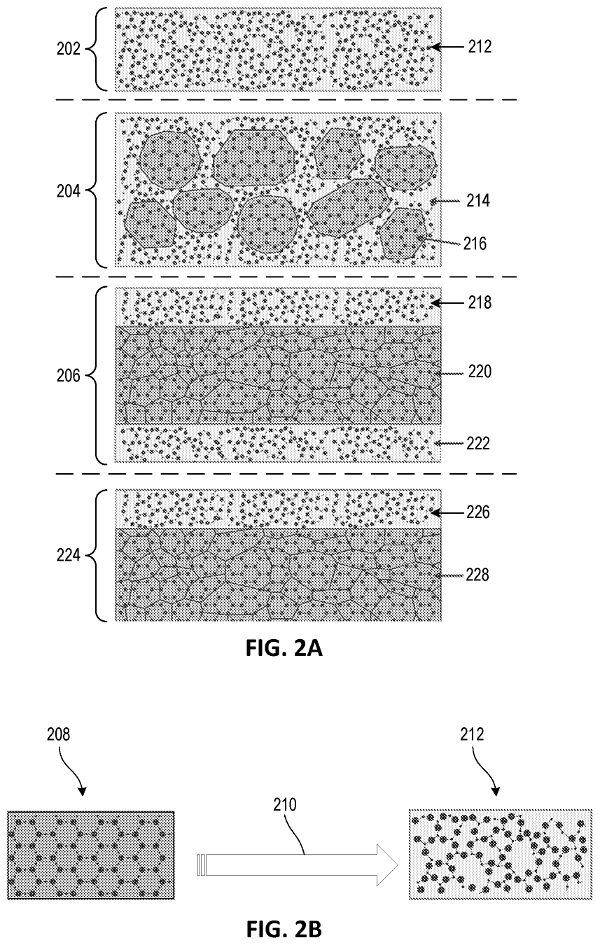

In some embodiments, the heating assembly can comprise a Joule heating system, microwave heating system, laser heating system, electron beam heating system, spark discharge heating system, or any other heating system capable of providing the sintering temperature, heating rate, and/or cooling rate. For example, the systems and methods for providing the high-temperature heating can be similar to those disclosed in International Publication No. WO 2020/236767, published Nov. 26, 2020 and entitled “High temperature sintering systems and methods,” and International Publication No. WO 2022/204494, published Sep. 29, 2022, published Sep. 29, 2022 and entitled “High temperature sintering furnace systems and methods,” both of which are incorporated herein by reference. For example, in some embodiments, the heating assembly can be a symmetric Joule heating assembly, such as that illustrated in FIG. 1B. Alternatively, in some embodiments, the heating assembly can be an asymmetric Joule heating assembly (e.g., a single heating element) or a symmetric Joule heating assembly asymmetrically actuated (e.g., with one heating element providing a higher temperature than the other, for example, as discussed below with respect to FIGS. 3B-3C).

The method 100 can proceed to decision block 104, where the desired microstructure for the fabricated material can be selected. If an all-glass phase material is desired, the method 100 can proceed from decision block 104 to process block 106, where the precursor material can be subjected to a first sintering temperature, T₁, that is at least 100° C. greater than the melting temperature, T_{M}, of the precursor material. For example, the first sintering temperature can be about 200° C. greater than the melting temperature of the precursor material (e.g., T₁≈1600-1700° C. for LLZO). In some embodiments, when using a Joule heating element and prior to applying the first sintering temperature, T₁, a low current can be applied to heat the Joule heating element to about 525° C. (~800 K), for example, to remove any absorbed gases.

The method 100 can proceed to decision block 108, where it is determined if the first sintering temperature has been applied for a sufficient time. For example, the first sintering temperature may be maintained until the precursor material begins to melt. In some embodiments, the first sintering temperature can be maintained for a time period less than 5 minutes (e.g., less than or equal to 60 seconds, such as in a range of 3-10 seconds, inclusive). If the end of the sintering time period has not yet been reached, the method 100 can return to process block 106, where the first sintering temperature is maintained.

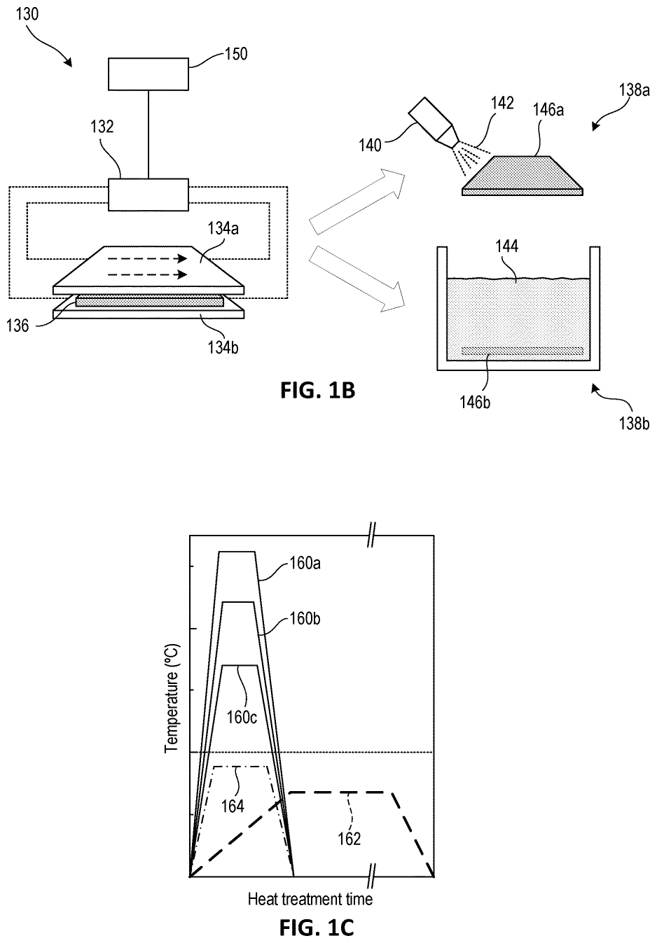

Otherwise, if the end of the sintering time period has been reached, the heating can cease (e.g., by decreasing the current through the Joule heating element to zero) and the method 100 can proceed from decision block 108 to process block 110. At process block 110, the heated material can immediately be cooled via liquid quenching, for example, by immersing the heated material in a bath of oil (e.g., mineral oil) at a lower temperature (e.g., room temperature, such as about 20-25° C.). With the sintering temperature being much higher than the melting point (e.g., ~200° C.) of the precursor material and with the liquid quenching yielding a fast cooling rate (e.g., initial cooling rate≥10³° C./s), for example, following the temperature profile 160a in FIG. 1C, an all-glass phase 212 can be achieved for the final microstructure 202, for example, as shown in FIG. 2A. The resulting glass material can then be used at process block 112, for example, in solid-state batteries or other applications.

Returning to decision block 104 in FIG. 1A, if an ITS material is desired, the method 100 can instead proceed to process block 114, where the precursor material is subjected to a second sintering temperature, T₂, that is between 50° C. and 100° C. greater than the melting temperature, T_{M}, of the precursor material (e.g., T2~1500-1600° C. for LLZO). For example, the second sintering temperature can be about 75° C. greater than the melting temperature of the precursor material. In some embodiments, when using a Joule heating element and prior to applying the second sintering temperature, T₂, a low current can be applied to heat the Joule heating element to about 525° C. (~800 K), for example, to remove any absorbed gases.

The method 100 can proceed to decision block 116, where it is determined if the second sintering temperature has been applied for a sufficient time. For example, the second sintering temperature may be maintained until the precursor material begins to melt. In some embodiments, the second sintering temperature can be maintained for a time period less than 30 seconds, for example, in a range of 3-10 seconds, inclusive. If the end of the sintering time period has not yet been reached, the method 100 can return to process block 114, where the second sintering temperature is maintained.

Otherwise, if the end of the sintering time period has been reached, the heating can cease (e.g., by decreasing the current through the Joule heating element to zero) and the method 100 can proceed from decision block 116 to process block 118. At process block 118, the heated material can immediately be cooled via air quenching, for example, by directing a flow of gas (e.g., inert gas, such as argon) at a lower temperature (e.g., room temperature, such as about 20-25° C.). With the sintering temperature being in an intermediate range above the melting point (e.g., 50-100° C.) of the precursor material and with the air quenching yielding an intermediate cooling rate (e.g., initial cooling rate≤0.5×10³° C./s), for example, following the temperature profile 106b in FIG. 1C, the ITS microstructure 204 can be achieved for the final product. For example, the flow of gas can be at a flow rate of 100-150 sccm. The ITS microstructure 204 can have islands 216 of crystalline grains (e.g., with grain size around 1-5 μm, inclusive) embedded or dispersed within a glass phase sea 214, for example, as shown in FIG. 2A. The resulting glass-crystalline hybrid material can then be used at process block 112, for example, in solid-state batteries or other applications.

Returning to decision block 104 in FIG. 1A, if glass-crystalline layers is desired, the method 100 can instead proceed to process block 120, where the precursor material is subjected to a third sintering temperature, T₃, that is no more than 50° C. greater than the melting temperature, T_{M}, of the precursor material. For example, the third sintering temperature can be about 25° C. greater than the melting temperature of the precursor material. In some embodiments, when using a Joule heating element and prior to applying the third sintering temperature, T₃, a low current can be applied to heat the Joule heating element to about 525° C. (~800 K), for example, to remove any absorbed gases.

The method 100 can proceed to decision block 122, where it is determined if the third sintering temperature has been applied for a sufficient time. For example, the third sintering temperature may be maintained until the precursor material begins to melt. In some embodiments, the third sintering temperature can be maintained for a time period less than 30 seconds, for example, in a range of 3-10 seconds, inclusive. If the end of the sintering time period has not yet been reached, the method 100 can return to process block 120, where the third sintering temperature is maintained.

Otherwise, if the end of the sintering time period has been reached, the heating can cease (e.g., by decreasing the current through the Joule heating element to zero) and the method 100 can proceed from decision block 122 to process block 118. At process block 118, the heated material can immediately be cooled via air quenching, for example, by directing a flow of gas (e.g., inert gas, such as argon) at a lower temperature (e.g., room temperature, such as about 20-25° C.). With the sintering temperature being only slightly higher than the melting point (e.g., <50° C.) of the precursor material and with the air quenching yielding a relatively low cooling rate, for example, following the temperature profile 106c in FIG. 1C, the sandwich microstructure 206 in FIG. 2A can be achieved for the final product. For example, the flow of gas can be at a flow rate of 100-150 sccm. As shown in FIG. 2A, the sandwich microstructure 206 can have outermost sublayers 218, 220 (e.g., top and bottom sublayers) with a glass phase and an intermediate polycrystalline sublayer 222 (e.g., with grain size around 1-5 μm, inclusive) disposed between the glass sublayers 218, 220. The resulting glass-crystalline hybrid material can then be used at process block 112, for example, in solid-state batteries or other applications.

Alternatively, in some embodiments, the heating during process block 120 can be asymmetrically applied (e.g., such that one surface of the material is heated more than an opposite surface), for example, to achieve the bi-layer microstructure 224 in FIG. 2A instead of the sandwich microstructure 206. For example, as shown in FIG. 2A, the bi-layer microstructure 224 can have a sublayer 226 (e.g., top sublayer) with a glass phase and a polycrystalline sublayer 222 (e.g., bottom sublayer, with grain size around 1-5 μm, inclusive). The resulting glass-crystalline hybrid material can then be used at process block 112, for example, in solid-state batteries or other applications.

In contrast to the heating profiles 160a-160c, the heating application for conventional sintering systems is performed at a lower temperature (e.g., less than the material melting temperature) and for a longer time (e.g., on the order of minutes or hours), for example as illustrated by temperature profile 162 in FIG. 1C. In addition, in prior pulsed heating systems by the present inventors (e.g., as disclosed in U.S. Publication No. 2022/0219986, published Jul. 14, 2022 and entitled “High Temperature Sintering Systems and Methods,” the heating systems of which are incorporated herein by reference), the heating application was also performed at a temperature less than the melting temperature, for example, as illustrated by temperature profile 164 in FIG. 1C.

Although illustrated separately, it is contemplated that various process blocks may occur simultaneously or iteratively. Furthermore, certain process blocks illustrated as occurring after others may indeed occur before. Although some of blocks 102-122 of method 100 have been described as being performed once, in some embodiments, multiple repetitions of a particular process block may be employed before proceeding to the next decision block or process block. In addition, although blocks 102-122 of method 100 have been separately illustrated and described, in some embodiments, process blocks may be combined and performed together (simultaneously or sequentially). Moreover, although FIG. 1A illustrates a particular order for blocks 102-122, embodiments of the disclosed subject matter are not limited thereto. Indeed, in certain embodiments, the blocks may occur in a different order than illustrated or simultaneously with other blocks. In some embodiments, method 100 may comprise only some of blocks 102-122 of FIG. 1A.

Referring to FIG. 1B, an exemplary Joule heating setup 130 and cooling setup 138 are illustrated. In any of the disclosed examples, the heating source (e.g., one or more Joule heating elements 134a, 134b) can subject the material 136 to a high-temperature heating period. For example, a control system 150 can control an electrical power source 132 (or alternatively, electrical power source 132 and control system 150 can be parts of a single unit) to apply a short-duration current pulse to the Joule heating element (e.g., with the current traveling through the respective heating element without passing through the material 136) that causes the heating element to rapidly increase to the sintering temperature, dwell at the sintering temperature for a predetermined time period, and then rapidly cool from the sintering temperature.

Depending on the type of precursor material (e.g., material composition, precursor versus crystalline member, etc.), the heating can be conducted in an open atmosphere (e.g., ambient air), restricted atmosphere (e.g., glovebox with argon, nitrogen, or other inert gas), vacuum atmosphere (e.g., vacuum chamber at a pressure less than 1 atm), or any other atmosphere. In some embodiments, the high-temperature heating can be terminated by conveying the heating element 134a, 134b and/or the material 136 out of a heating zone and/or by de-activating, de-energizing, or otherwise terminating operation of the heating elements.

In some embodiments, cooling at the end of a heating period can be achieved using one or more passive cooling features (e.g., heat sinks thermally coupled to the heating element and/or sintered structures, etc.), one or more active cooling features (e.g., fluid flow directed at the sintered structures and/or the heater, fluid flow through a heat sink thermally coupled thereto, etc.), or any combination thereof. For example, if air quenching is desired, the heated material 136 can be directed from the heating setup 130 to cooling setup 138a, where one or more nozzles 140 are used to direct a gas flow 142 (e.g., an inert gas) at sufficient velocity and pressure (e.g., at least 100 sccm) to cool the heated material 146 a, thereby forming the at least partially glass phase material. Alternatively, if liquid quenching is desired, the heated material can instead be directed from the heating setup 130 to cooling setup 138b, where the heated material 146b is immersed in a liquid 144 (e.g., oil or water). Other cooling configurations beyond those specifically illustrated are also possible according to one or more contemplated embodiments, such as, but not limited to, using multiple nozzles to direct air flow at different portions of the precursor, spraying liquid onto the heated material, and/or integrating the cooling stage with the heating stage (e.g., such that the precursor does not have to leave the heating stage in order to be cooled).

FIG. 2A illustrates cross-sections of fabricated pellets for three different microstructures: (1) the complete glassy material 202, (2) the “island-in-the-sea” (ITS) material 204 that features crystalline grains 216 separated by a surrounding glass phase 214, (3) a trilayer material 206 with crystalline phase 220 sandwiched between two glassy layers 218, 222, and (4) a bilayer material 224 with glassy layer 226 on a polycrystalline phase 228. As discussed above and elsewhere herein, these structures can be achieved by controlling the synthesis parameters. By heating the pellet to a high temperature and then rapidly cooling, the resulting membrane will feature a pure glass phase 202, while relatively slow cooling rate will result in the ITS structure 204. In contrast, when the sintering temperature is only slightly above the melting point of the pellet and the pellet is cooled at a relatively slow rate, the glass phase may only present as thin layers 218, 222 on the surfaces of the material 206, or a thin layer 226 on only one surface of the material 224. In all these materials 202, 204, 206, and 224, the phase near the surface will be glass due to the higher temperature and faster cooling rate in these regions. In each case, the glass phase is continuous, and no phase boundaries are present, in contrast to common polycrystalline membranes.

In some embodiments, the approach described above and elsewhere herein can also be applied to fabricate metallic glass. For example, FIG. 2B shows an exemplary schematic to transform a crystalline metal 208 into metallic glass 212 via a high-temperature heating period followed by rapid cooling 210. In some embodiments, Joule heating can quickly increase the temperature to, for example, 3000° C. in seconds, which is much higher than conventional methods. This can offer reasonable temperature ranges to modulate the quenching parameters and can be favorable to the formation of metallic glass with high crystalline melting points (Tₘ) and relatively low reduced glass transition temperatures (T_{rg}, e.g., Cu—Zr—Ti or Zr—Al—Ni systems with Tₘ ~1100-1200 K and T_{rg} ~0.57-0.6). The as-synthesized metallic glasses can present advantages in mechanical properties (e.g., large strength and hardness, with low modulus, large compressive and shear deformation), corrosion resistance, as well as thermal stability.

FIG. 3A shows another method 300 for fabricating a material (e.g., bulk pellet, layer, film, or other structure formed of ceramic and/or metal) with control over its microstructure, in particular, by controlling crystal growth and orientation. The method 300 can initiate at process block 302, where a precursor material can be provided with respect to a heating assembly. In some embodiments, the precursor material can comprise one or more precursors, for example, to be sintered and/or react together to form one or more layers. Alternatively or additionally, in some embodiments, the precursor material can comprise a pre-fabricated polycrystalline or single-crystal member, for example, a crystalline membrane to be converted to a textured electrolyte.

The method 300 can proceed to process block 308, where the precursor material (e.g., having a maximum cross-sectional dimension (e.g., diameter) in a range of 5-20 mm, inclusive, and a minimum cross-sectional dimensions (e.g., thickness) in a range of 0.1-1 mm, inclusive) is heated by a thermal gradient. For example, one side of the precursor material 136 may be subjected to a first temperature, T4, (e.g., about 50-100° C. less than a melting temperature of the precursor material) by heating element 322 and the opposite side of the precursor material 136 may be subjected to a lower second temperature, T5, (e.g., about 150-250° C. less than the melting temperature of the precursor material) by a second heating element 324, such that a spatial thermal gradient 332 is established within the precursor material 136, as shown in FIG. 3B. The precursor material can be subject to the thermal gradient 332 for the duration of a sintering period (e.g., less than 5 minutes, such as ≤60 seconds).

In some embodiments, the precursor material can be heated by a heating assembly similar to that described above with respect to FIGS. 1A-1B, but controlled or otherwise configured to generate a thermal gradient. For example, in a Joule heating assembly, the heating element on one side of the precursor material can have a different size than the heating element on the opposite side of the precursor material, such that application of the same current to the heating elements results in different levels of heating. Alternatively or additionally, the heating elements can be separately controlled (e.g., via independent power sources or supplies) to achieve different temperatures (e.g., by applying different power to each heating element).

For example, FIG. 3C shows an exemplary Joule heating setup 340 that can be used to subject the precursor material 136 to a thermal gradient. The Joule heating setup 340 can include a first heating element 346 connected to a first power supply 342 and a second heating element 348 connected to a second power supply 344. Operation of the power supplies 342, 344 can be controlled by a control system 350, for example, to independently apply short-duration current pulses to the respective heating elements 446, 448 (e.g., with the current traveling through the respective heating element without passing through the material 136) with a fixed power differential therebetween (e.g., 200-500 W), thereby inducing a thermal gradient within the material 136. In some embodiments, the functions of the control system 350, the first power supply 342, and/or the second power supply 344 can be combined into a single unit (e.g., a programmable power supply with independently controllable outputs).

Returning to FIG. 3A, the method 300 can proceed to decision block 306, where it is determined if the thermal gradient has been applied for a sufficient time. For example, the thermal gradient may be maintained for a time period less than 5 minutes (e.g., less than or equal to 60 seconds, such as in a range of 10-15 seconds, inclusive). If the end of the sintering time period has not yet been reached, the method 300 can return to process block 304, where the thermal gradient is maintained.

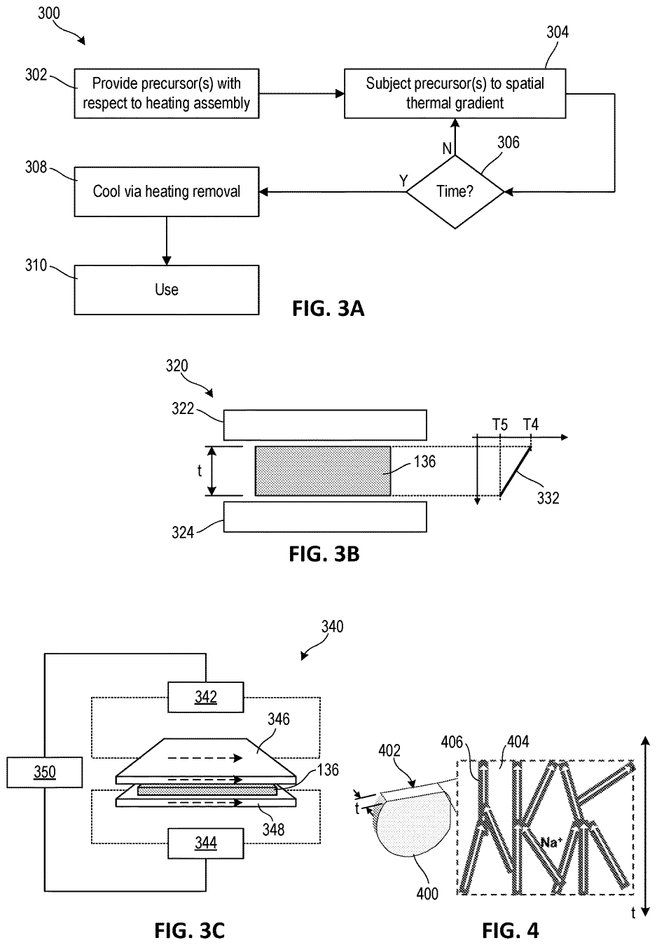

Otherwise, if the end of the sintering time period has been reached, the heating can cease (e.g., by decreasing the current through the Joule heating element to zero) and the method 300 can proceed from decision block 306 to process block 308. At process block 308, the heated material can be cooled via natural quenching after heat removal, for example, exposing (e.g., both sides previously facing the heating elements) to static air at a lower temperature (e.g., room temperature, such as about 20-25° C.). In some embodiments, the natural quenching can provide a cooling rate of at least 10²° C./s, for example, in a range of 2×10²° C./s to 10³° C./s. This asymmetric heating followed by rapid quenching can generate a non-equilibrium temperature distribution that causes the textured ceramic material 400 to have needle-like crystal grains 404 substantially aligned along its thickness direction, t, with conducting planes 406 (e.g., for Na ions) along the long ends of grains 404, as shown in FIG. 4. The resulting textured ceramic can then be used at process block 310, for example, as an electrolyte in solid-state batteries or other applications.

Although illustrated separately, it is contemplated that various process blocks may occur simultaneously or iteratively. Furthermore, certain process blocks illustrated as occurring after others may indeed occur before. Although some of blocks 302-310 of method 300 have been described as being performed once, in some embodiments, multiple repetitions of a particular process block may be employed before proceeding to the next decision block or process block. In addition, although blocks 302-310 of method 300 have been separately illustrated and described, in some embodiments, blocks may be combined and performed together (simultaneously or sequentially). Moreover, although FIG. 3A illustrates a particular order for blocks 302-310, embodiments of the disclosed subject matter are not limited thereto. Indeed, in certain embodiments, the blocks may occur in a different order than illustrated or simultaneously with other blocks. In some embodiments, method 300 may comprise only some of blocks 302-310 of FIG. 3A.

### Battery Systems

In some embodiments, the sintered material having at least a partial glass phase microstructure can be formed as an ion conductor, for example, to conduct metal ions (e.g., alkali metal ions, such as lithium (Li) ions, sodium (Na) ions, potassium (K) ions, etc., alkaline earth metal ions, such as magnesium (Mg), and/or anions (e.g., oxygen (O) ions). In some embodiments, the sintered material can include the element corresponding to the desired ion to be conducted, among other constituent elements. For example, when the ion-conducting structure is used as an SSE for a Li ion battery, the sintered material composition can comprise Li, and when the ion-conducting structure is used as an SSE for a Na ion battery, the sintered material composition can comprise Na. In contrast to amorphous oxide solid electrolytes formed via other methods (e.g., sputtering), embodiments of the disclosed subject matter can exhibit enhanced ion conductivity and thus can be used as an ion conductor (e.g., SSE in a battery). For example, the ion-conducting structure having one of the disclosed glass phase microstructures can be an oxide and can have an ion conductivity of at least 10⁻⁴ S/cm.

In some embodiments, the sintered material composition can satisfy a chemical formula of Li_{A}La_{B}M′_{C}M″_{D}Zr_{E}O_{F}, Li_{A}La_{B}M′_{C}M″_{D}Ta_{E}O_{F}, or Li_{A}La_{B}M′_{C}M″_{D}Nb_{E}O_{F}, where 4<A<8.5, 1.5<B<4, 0≤C≤2, 0≤D≤2, 0≤E<2, and 10<F<13, M′ is a first one selected from Al, Mo, W, Nb, Sb, Ca, Ba, Sr, Ce, Hf, Rb, or Ta, and M″ is a second one selected from Al, Mo, W, Nb, Sb, Ca, Ba, Sr, Ce, Hf, Rb, or Ta. Alternatively, is some embodiments, the sintered material composition can satisfy a chemical formula of Li_{A}La_{B}Zr_{C}Al_{D}M″′_{E}O_{F}, where 5<A<7.7, 2<B<4, 0<C≤2.5, 0≤D<2, 0≤E<2, and 10<F<13, and M″′ is Nb, Ta, V, W, Mo, or Sb. For example, the SSE with at least partial glass microstructure can be selected from the group consisting of perovskite-type Li₃ₓLa_{2/3-x}TiO₃, NASICON-type Li_{1.3}Al_{0.3}Ti_{1.7}(PO₄)₃, NASICON-type Li₁₊ₓAlₓGe₂₋ₓ(PO₄)₃, garnet-type Li₇La₃Zr₂O₁₂ (LLZO), garnet-type Li₇La₃Zr_{1.4}Ta_{0.6}O₁₂ (LLTZO), LISICON-type Li₁₄Zn(GeO₄)₄, thio-LISICON-type Li₄₋ₓGe₁₋ₓPₓS₄, argyrodite-type Li₆PS₅Cl, and anti-perovskite-type Li₃OCl. In some embodiments, the SSE with at least partial glass microstructure can comprise (i) lithium lanthanum zirconate (LLZO); (ii) glassy sodium polyaluminate; (iii) yttria-stabilized zirconia (YSZ); (iv) yttrium monosilicate (YMS); or (v) yttrium disilicate (YDS).

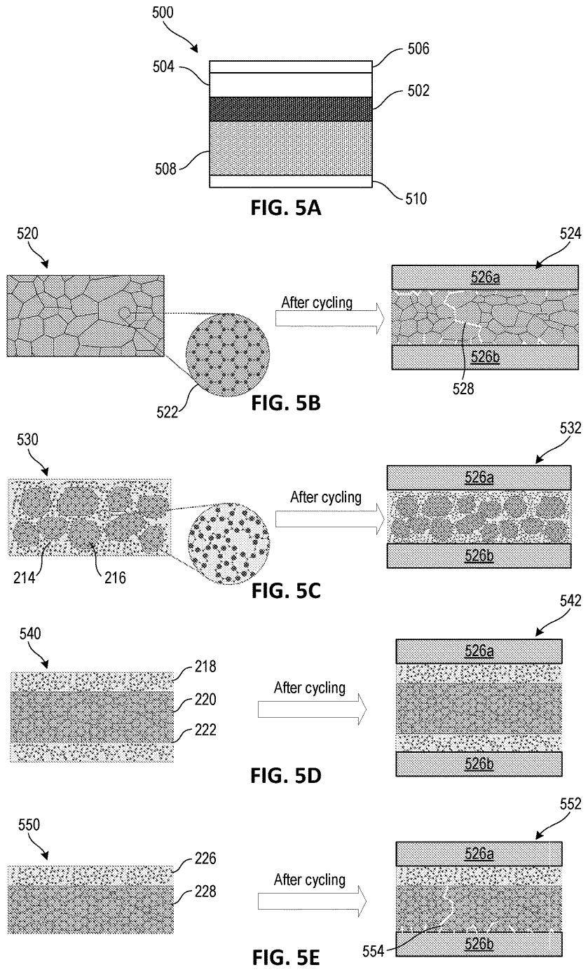

FIG. 5A illustrates an exemplary configuration of a battery 500 (e.g., primary battery or secondary battery) that can utilize the at least partial glass microstructure material as one or more components thereof, for example, solid-state electrolyte (SSE) 502. The battery 500 can include an anode 504 and a cathode 508 disposed on opposite sides of the SSE 502 (e.g., having a thickness less than or equal to 1 mm, for example, in a range of 5-1000 μm). In some embodiments, the anode 504 and/or cathode 508 can be formed separate from the SSE 502 and subsequently coupled thereto to form battery 500. Alternatively or additionally, in some embodiments, the anode 504 and/or cathode 508 can be integrally formed on the SSE 502 or with the SSE 502, for example, via the sintering method disclosed in International Publication No. WO 2020/236767, published Nov. 26, 2020 and entitled “High temperature sintering systems and methods,” which is incorporated herein by reference.

Through respective electrical contacts 506, 510 (also referred to as current collectors), the battery 500 may be coupled via an appropriate electrical circuit to an electrical load for use of charge stored by the battery or a power source for recharging the battery. In some embodiments, the battery 500 can be a Li ion battery or a Na ion battery. For example, anode 504 can be formed of solid Li metal. In polycrystalline materials 520, grain boundaries exist because neighboring grains have different lattice orientations 522, as shown in FIG. 5B. For crystalline electrolyte, the high electronic conductivity and reactivity of the grain boundaries offers ions (e.g., Li or Na) a pathway 528 for migration (e.g., percolation network), which could result in a short-circuit between the electrodes 526a, 526b due to dendrite growth (e.g., penetration of Li metal through the SSE) after cycling, as shown at 524. For example, dendrites can arise from the high reactivity of the grain boundaries with Li metal. While amorphous oxide electrolyte (e.g., lithium phosphorus oxynitride (LiPON)) may help address the above-noted issue by avoiding grain boundaries that encourage Li dendrites, conventional amorphous oxide electrolytes suffer from low ionic conductivity (e.g., LiPON exhibits an ionic conductivity up to 10⁻⁶ S/cm) and/or poor stability with Li metal.

Thus, in some embodiments, the use of an SSE having an at least partially glass phase microstructure can help eliminate grain boundaries and thereby eliminate, or at least reduce, the occurrence of dendrite penetration. For example, crystalline garnet-type electrolyte (e.g., LLZO) can be converted to an ITS phase 530 without grain boundaries by sintering (e.g., above 1600° C. for 5 seconds) followed by gas quenching to room temperature, as shown in FIG. 5C. The ITS electrolyte can possess higher stability due to the elimination of the high electronic conductive grain boundaries, which blocks the migration of the metal ion (e.g., Li). As a result, the ITS electrolyte 532 can be cycled at high current density (e.g., 10 mA/cm² for more than 1000 hours, and with a maximum current density of 16 mA/cm² ) without shorting. Similarly, the continuous glass phase layer (e.g., either glass sublayer 218 or 222 in the sandwich microstructure configuration 540 of FIG. 5D, or the glass sublayer 226 in the bilayer microstructure configuration 550 of FIG. 5E) proximal to the anode can help block the metal ion penetration 554 and avoid, or at least reduce, Li dendrite formation (e.g., as shown by cycled electrolytes 542, 552 in FIGS. 5D-5E).

### Computer Implementation Examples

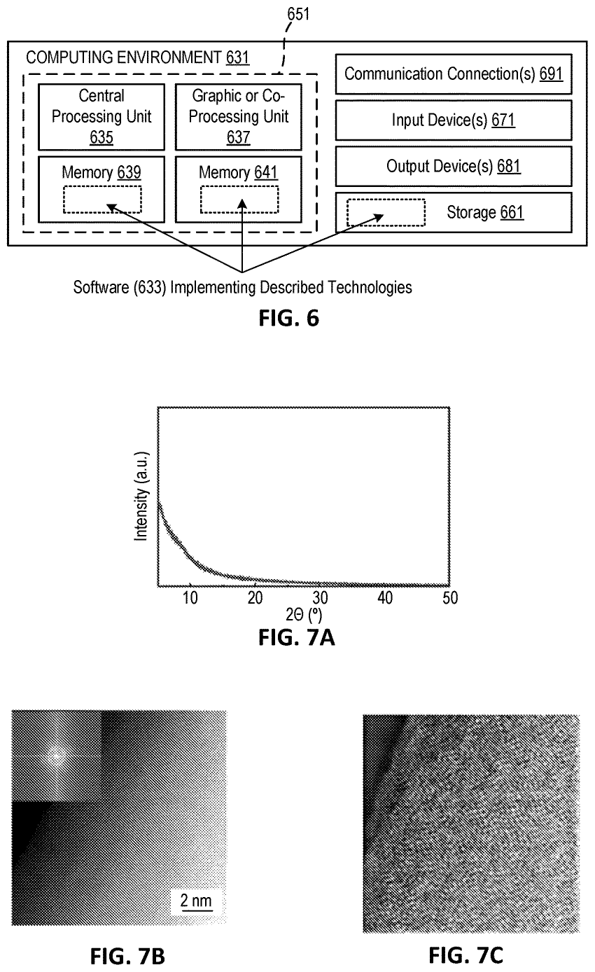

FIG. 6 depicts a generalized example of a suitable computing environment 631 in which the described innovations may be implemented, such as but not limited to method 100, control system 150, method 300, and/or control system 350. The computing environment 631 is not intended to suggest any limitation as to scope of use or functionality, as the innovations may be implemented in diverse general-purpose or special-purpose computing systems. For example, the computing environment 631 can be any of a variety of computing devices (e.g., desktop computer, laptop computer, server computer, tablet computer, etc.).

With reference to FIG. 6, the computing environment 631 includes one or more processing units 635, 637 and memory 639, 641. In FIG. 6, this basic configuration 651 is included within a dashed line. The processing units 635, 637 execute computer-executable instructions. A processing unit can be a central processing unit (CPU), processor in an application-specific integrated circuit (ASIC), or any other type of processor (e.g., hardware processors, graphics processing units (GPUs), virtual processors, etc.). In a multi-processing system, multiple processing units execute computer-executable instructions to increase processing power. For example, FIG. 6 shows a central processing unit 635 as well as a graphics processing unit or co-processing unit 637. The tangible memory 639, 641 may be volatile memory (e.g., registers, cache, RAM), non-volatile memory (e.g., ROM, EEPROM, flash memory, etc.), or some combination of the two, accessible by the processing unit(s). The memory 639, 641 stores software 633 implementing one or more innovations described herein, in the form of computer-executable instructions suitable for execution by the processing unit(s).

A computing system may have additional features. For example, the computing environment 631 includes storage 661, one or more input devices 671, one or more output devices 681, and one or more communication connections 691. An interconnection mechanism (not shown) such as a bus, controller, or network interconnects the components of the computing environment 631. Typically, operating system software (not shown) provides an operating environment for other software executing in the computing environment 631, and coordinates activities of the components of the computing environment 631.

The tangible storage 661 may be removable or non-removable, and includes magnetic disks, magnetic tapes or cassettes, CD-ROMs, DVDs, or any other medium which can be used to store information in a non-transitory way, and which can be accessed within the computing environment 631. The storage 661 can store instructions for the software 633 implementing one or more innovations described herein.

The input device(s) 671 may be a touch input device such as a keyboard, mouse, pen, or trackball, a voice input device, a scanning device, or another device that provides input to the computing environment 631. The output device(s) 681 may be a display, printer, speaker, CD-writer, or another device that provides output from computing environment 631.

The communication connection(s) 691 enable communication over a communication medium to another computing entity. The communication medium conveys information such as computer-executable instructions, audio or video input or output, or other data in a modulated data signal. A modulated data signal is a signal that has one or more of its characteristics set or changed in such a manner as to encode information in the signal. By way of example, and not limitation, communication media can use an electrical, optical, radio-frequency (RF), or another carrier.

Any of the disclosed methods can be implemented as computer-executable instructions stored on one or more computer-readable storage media (e.g., one or more optical media discs, volatile memory components (such as DRAM or SRAM), or non-volatile memory components (such as flash memory or hard drives)) and executed on a computer (e.g., any commercially available computer, including smart phones or other mobile devices that include computing hardware). The term computer-readable storage media does not include communication connections, such as signals and carrier waves. Any of the computer-executable instructions for implementing the disclosed techniques as well as any data created and used during implementation of the disclosed embodiments can be stored on one or more computer-readable storage media. The computer-executable instructions can be part of, for example, a dedicated software application or a software application that is accessed or downloaded via a web browser or other software application (such as a remote computing application). Such software can be executed, for example, on a single local computer (e.g., any suitable commercially available computer) or in a network environment (e.g., via the Internet, a wide-area network, a local-area network, a client-server network (such as a cloud computing network), or any other such network) using one or more network computers.

For clarity, only certain selected aspects of the software-based implementations are described. Other details that are well known in the art are omitted. For example, it should be understood that the disclosed technology is not limited to any specific computer language or program. For instance, aspects of the disclosed technology can be implemented by software written in C++, Java™, Python®, and/or any other suitable computer language. Likewise, the disclosed technology is not limited to any particular computer or type of hardware. Certain details of suitable computers and hardware are well known and need not be set forth in detail in this disclosure.

It should also be well understood that any functionality described herein can be performed, at least in part, by one or more hardware logic components, instead of software. For example, and without limitation, illustrative types of hardware logic components that can be used include Field-programmable Gate Arrays (FPGAs), Program-specific Integrated Circuits (ASICs), Program-specific Standard Products (ASSPs), System-on-a-chip systems (SOCs), Complex Programmable Logic Devices (CPLDs), etc.

Furthermore, any of the software-based embodiments (comprising, for example, computer-executable instructions for causing a computer to perform any of the disclosed methods) can be uploaded, downloaded, or remotely accessed through a suitable communication means. Such suitable communication means include, for example, the Internet, the World Wide Web, an intranet, software applications, cable (including fiber optic cable), magnetic communications, electromagnetic communications (including RF, microwave, and infrared communications), electronic communications, or other such communication means. In any of the above-described examples and embodiments, provision of a request (e.g., data request), indication (e.g., data signal), instruction (e.g., control signal), or any other communication between systems, components, devices, etc. can be by generation and transmission of an appropriate electrical signal by wired or wireless connections.

### EXAMPLES AND EXPERIMENTAL RESULTS

### Example 1: Li—La—Zr—O Solid-State Electrolyte Membrane

The three types of Li—La—Zr—O solid-state electrolyte membranes (e.g., complete glass, ITS and sandwiched structure) can be directly derived from the garnet-type Li₇La₃Zr₂O₁₂ electrolyte via a fast ultrahigh temperature heating/cooling treatment. The LLZO powders were directly synthesized via a solid-state reaction method. Precursors were stoichiometrically mixed, and ball milled. The mixed powders were then calcined in air to form garnet phase. Membranes were further prepared by the tape-casting or mold press method with the garnet powders. High temperature sintering of membrane samples by electrical Joule heating was conducted in an argon-filled atmosphere. The samples were isostatically sandwiched between two layers of carbon felt, and current gradually increased until the temperature of samples becomes 10-200° C. higher than its melting point (e.g., around 1200° C.) for seconds (e.g., 5-10 seconds), followed by an immediate decrease of current to zero. Upon turning off the current supply, active cooling operations such as gas blowing (e.g., argon flow) or liquid quenching (e.g., mineral oil immersion) were executed to quickly reduce the temperature of the samples.

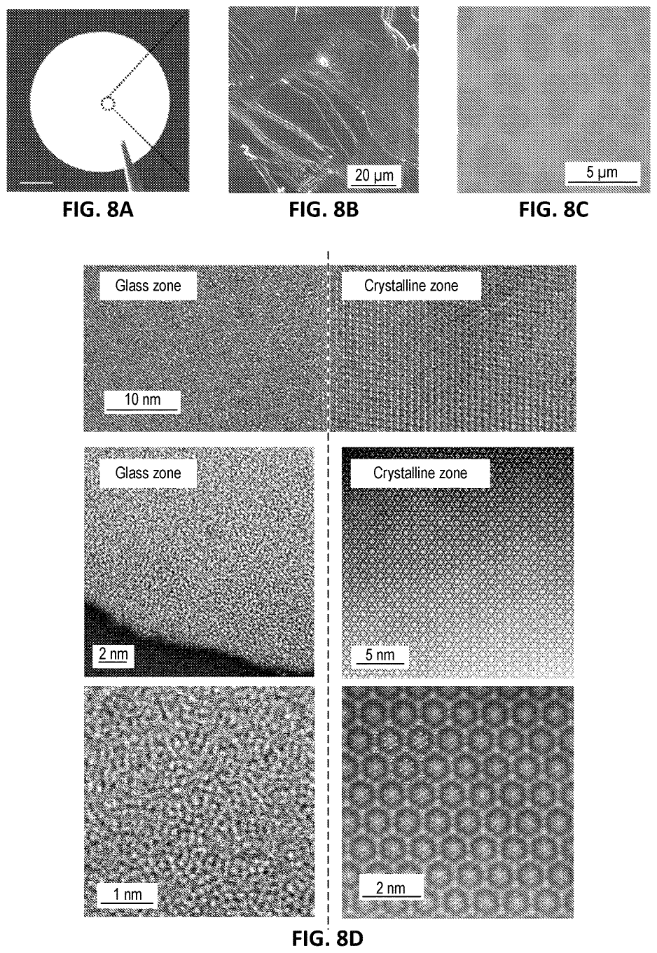

The amorphous feature of the LLZO pellet was proved by X-ray diffraction (XRD) characterization, with fewer or even no defined peaks attributed to garnet displayed in the XRD pattern (FIG. 7A) In FIG. 7A, the inset image shows the fast Fourier transform (FFT) of the two regions, which confirmed the typical feature of amorphous and crystalline lattices (e.g., the ring structure corroborated the amorphous structure of the electrolyte). Moreover, HAADF STEM analysis confirms the glass state of the LLZO (FIGS. 7B-7C). At the same time, the glass-phase-containing electrolyte preserves excellent mechanical properties and Li-ion conductivity. Therefore, for each of the three glass structures, solid-state electrolytes can be achieved with both good ion conductivity and superior ability for suppressing lithium penetration.

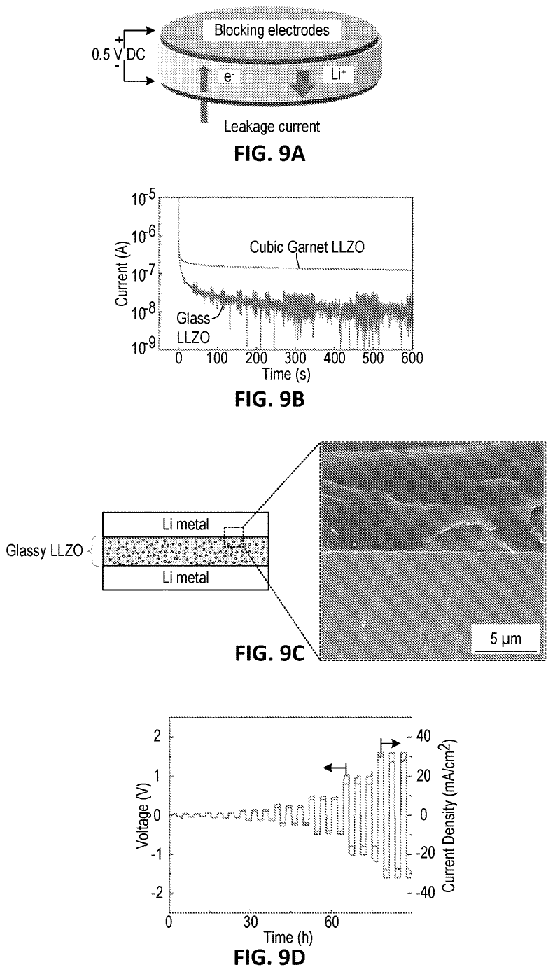

When these glass-phase-containing LLZO electrolyte structures are employed in solid-state batteries, lithium dendrites cannot extend into the electrolyte through grain boundaries, in contrast to conventional polycrystalline electrolytes. The glassy nature and the ITS morphology can is reflected in the images (with and without polishing) shown in FIGS. 8A-8C. In particular, FIG. 8A shows the surface of the LLZO electrolyte with ITS microstructure after a surface polishing treatment. Compared with the garnet-type crystalline electrolyte, the LLZO glass electrolyte presents translucent features as the grain boundaries are eliminated. FIG. 8C shows scanning electron microscopic (SEM) images of the cross-section of the LLZO glass electrolyte milled by argon ions at a temperature of −30° C., in which small grains (e.g., islands) with an average size of 2 μm can be found dispersed in the glass electrolyte (e.g., sea). FIG. 8D shows transmission electron microscopic (TEM) images of the interface between the glass and crystalline regions of the same LLZO material. Unlike other composite electrolytes, a smooth transition can be achieved because of the good atomic matching between the two regions. A negligible interface impedance would be expected. The right-side of FIG. 8D further shows scanning transmission electron microscopic (STEM) images for a small region of the crystalline electrolyte, in which the crystalline lattice fringes revealed the zone axis is [111], while the left-side of FIG. 8D further shows the STEM image for the glass electrolyte region, in which the sample presents an amorphous feature and no crystalline lattice fringes.

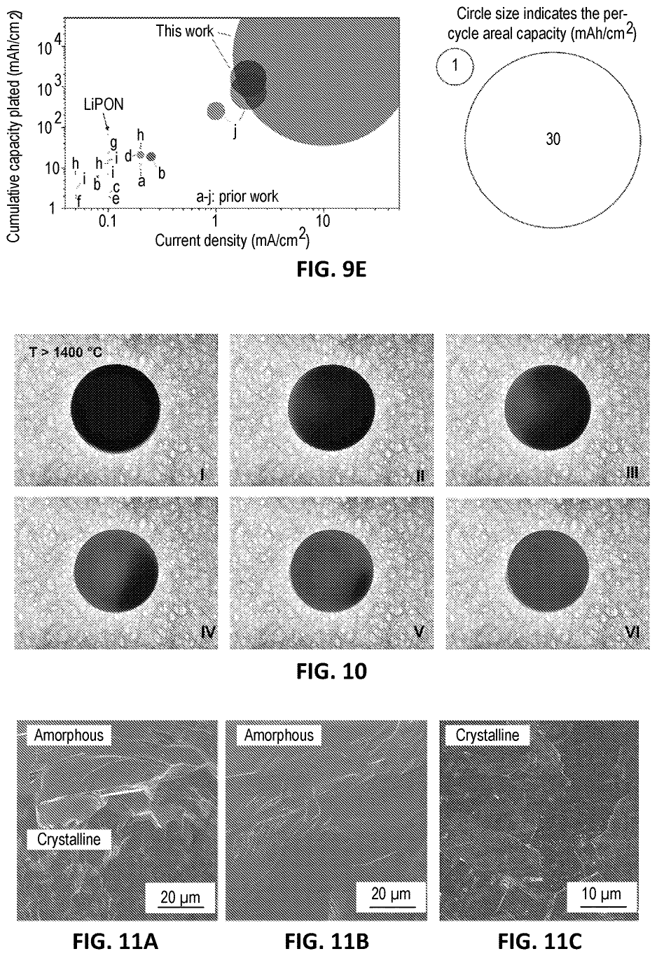

To better understand the electronic conductivity of the glass electrolyte, potential step chronoamperometry was conducted to investigate the electrical properties of the glass LLZO electrolyte. A schematic of the chronoamperometry experiment is shown in FIG. 9A, in which a glass LLZO pellet has been symmetrically coated with a layer of ion-blocking Pt as the electrode. The chronoamperometry experiment was carried out by applying a small step voltage of 0.5 V to the electrolyte matrix and observing the resultant steady-state current. A pair of ion-blocking Pt electrodes ensures that, while electrical current is allowed to pass through the device, faradaic activity is inhibited over time. As a result, the portion of the total current corresponding to the ionic current becomes transient and decays to zero, as shown in FIG. 9B. The remaining contribution to the steady-state current gives an indication of the electrical conductivity of the matrix, with lower values of current corresponding to a higher degree of insulation.

The steady-state current value of the crystalline garnet-type and glass LLZO electrolyte were compared. As shown in FIG. 9B, leakage current is allowed through the electrolyte matrix. Crystalline garnet-type LLZO showed the highest steady-state current at 2.0×10⁻⁷ A, corresponding to relatively poor electron blocking at the interface. Crystalline LLZO electrolytes with significant leakage current are vulnerable to dendrite formation during cycling, as electrons from the anode will pass readily into the electrolyte, reducing Li at the grain boundaries and pore surfaces. Remarkably, the glass electrolyte can drastically decrease the allowed leakage current across the device, roughly one order of magnitude lower than the LLZO pellet alone (~10⁻⁸ A), reaching the measurement capability of the potentiostat, which has minimum signal value of 1.00×10⁻⁸ A, suggesting a decrease in the leakage current of the device by at least another order of magnitude. Thus, the glass transition can lower the electronic leakage current dramatically and reduce the electronic conductivity by eliminating the grain boundaries.

To evaluate the cycling capability of the glass electrolyte, it was attempted to melt Li metal on the surfaces of the glass electrolyte. Note that all the previous surface engineering methods for crystalline LLZO to address the Li metal-electrolyte interphase issues can also work well on the glass electrolyte including atomic layer deposition (ALD) of ZnO₂ or Al₂O₃, as well as alloy techniques (e.g., adding Sn powder). The cross-sectional SEM image of FIG. 9C indicates a good contact between the Li metal and the glass electrolyte. To evaluate the current density limit that the glass electrolyte can reach, the critical current density (CCD) was measured at different current density and a duration of 2 hours for each half cycle. As shown in FIG. 9D, the Li-glass LLZO-Li symmetric cell exhibited a much more stable performance than other crystalline ceramic electrolytes. The CCD value can reach 16 mA/cm², even higher than some liquid electrolyte batteries.

FIG. 9E is a comparison of the per-cycle areal capacity (i.e., the areal capacity of Li plated for each cycle), the current density during plating/stripping, and the cumulative capacity of the plated Li prior to short circuit or cell failure for glass electrolytes as compared to existing inorganic electrolyte or inorganic-polymer composite electrolytes. For example, the ITS electrolyte can cycle at higher current densities (e.g., 15 mA/cm²) and can offer larger per-cycle areal capacities (e.g., up to 15 mA-h/cm²) for a cumulative plating capacity of 1200 mA-h/cm².

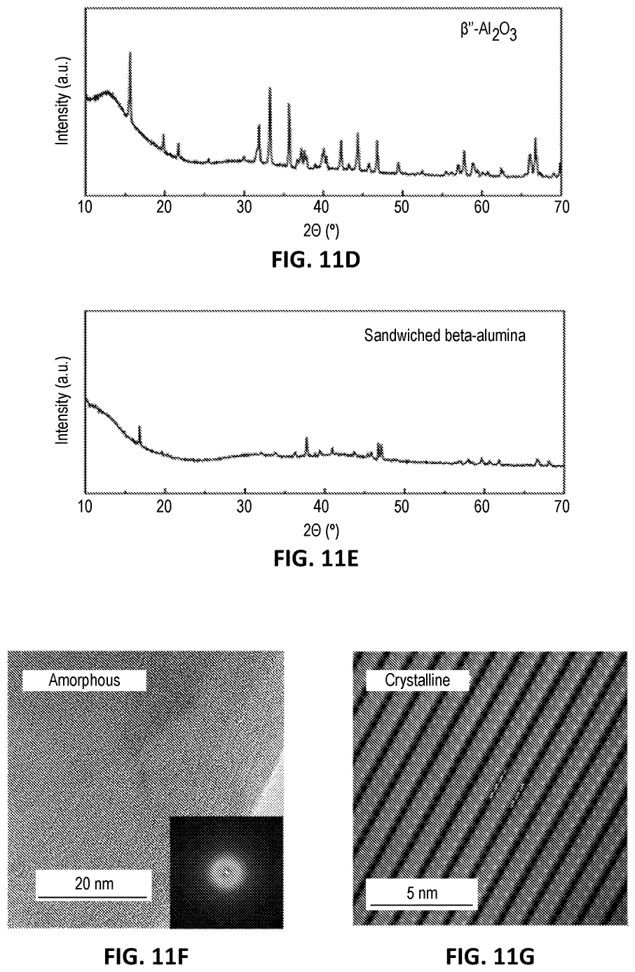

As discussed above, the microstructure of the glass electrolyte can be adjusted via control of the sintering temperature (e.g., with respect to the material melting temperature) and the cooling rate. For example, FIG. 10 shows the liquification transition of the LLZO crystalline electrolyte at a temperature above 1400° C. As shown, the pellet fast changes from opaque to translucent state when the temperature is above 1400° C.

Four types of electrolytes are disclosed herein based on the parameter adjustment: Type I is the monolith glass electrolyte with all compositions transformed into a glass state (e.g., material 202 in FIG. 2A), achieved via thermal profile 160a in FIG. 1C; Type II is the ITS structure in which the crystalline grains are like islands embedded in the glass electrolyte (sea) (e.g., material 204 in FIG. 2A), achieved via thermal profile 160b in FIG. 1C; Type III is the sandwich structure with the crystalline electrolyte in between two thin glass layers on the surfaces (e.g., material 206 in FIG. 2A), achieved via thermal profile 160c in FIG. 1C; and Type IV is the bilayer structure with the a thin glass layer on the surface of a crystalline electrolyte (e.g., material 224 in FIG. 2A), achieved via thermal profile 160c in FIG. 1C that was asymmetrically applied to only one surface. All disclosed types of glassy structures can effectively block the Li dendrite growth by eliminating the direct contact of grain boundary with Li metal.

### Example 2: Sodium Ion Conductor Membrane Derived from Beta-Alumina

Conventional sodium solid-state electrolytes, such as NASICON or beta-alumina, can face similar dendrite issue with Li solid-state electrolytes. Embodiments of the disclosed subject matter can be broadly employed for the sodium solid-state electrolyte and potentially address the dendrite issue. All disclosed structures (e.g., complete glass electrolyte, ITS electrolyte, the sandwiched electrolyte, and the bi-layer electrolyte as shown in FIG. 2A) can be employed for the sodium ion conductor; however, only one example is provided hereinbelow as a proof of concept. In particular, beta-alumina (β″-Al₂O₃) powders were directly synthesized via a solid-state reaction method. Precursors were stoichiometrically mixed, and ball milled. The mixed powders were calcined in air to form beta-alumina phase. Membranes were further prepared by the tape-casting or mold press method with the beta-alumina powders. High temperature sintering of membrane samples by electrical Joule heating was conducted in an argon-filled atmosphere. The samples were sandwiched between two layers of carbon felt, and current gradually increased until the temperature of samples becomes 10-200° C. higher than its melting point for seconds, followed by an immediate decrease of current to zero. Upon turning off the current supply, active cooling operations such as gas blowing or liquid quenching were executed to quickly reduce the temperature of the samples.

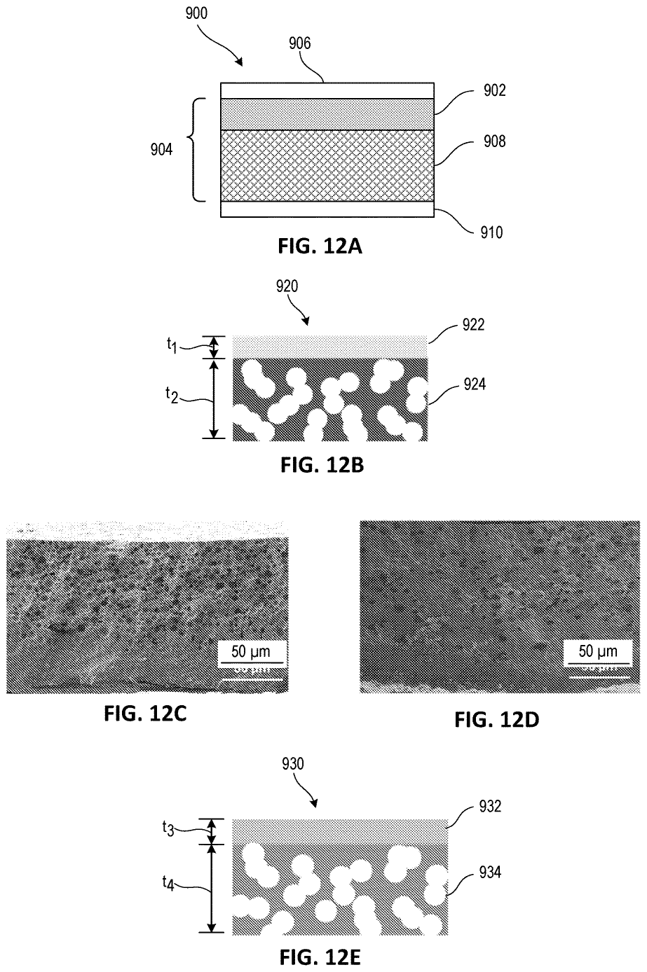

FIGS. 11A-11C show the sandwiched structure derived from beta-alumina, which is a promising sodium solid-state electrolyte for sodium batteries. FIGS. 11D-11E compare the X-ray diffraction (XRD) patterns for pure crystalline beta-alumina and the sandwiched structure derived from beta-alumina, in which the sandwiched structure presents weaker peaks that confirm the existence of glass states. FIGS. 11F-11G show scanning transmission electron microscopy (STEM) images of amorphous and crystalline phases, respectively, in the alumina sandwich structure of FIG. 11A.

### Example 3: Yttria Electrolytes

For yttria-stabilized zirconia (YSZ) electrolyte (e.g., a high-temperature oxygen ion conductor), all disclosed structures (e.g., complete glass electrolyte, ITS electrolyte, the sandwiched electrolyte, and the bi-layer electrolyte, as shown in FIG. 2A) can be employed; however, only one example is provided hereinbelow as a proof of concept. The new glassy/crystalline YSZ membrane material was directly derived from the polycrystalline YSZ via a fast ultrahigh temperature heating/cooling treatment. Common YSZ pellets can be prepared by uniaxial pressing and then isostatic pressing of commercial YSZ powders. High temperature sintering of membrane samples was conducted in an argon-filled atmosphere. The samples were sandwiched between two layers of carbon felt, and current gradually increased until the temperature of samples was higher than its melting point for seconds, followed by an immediate decrease of current to zero. Upon turning off the current supply, active cooling operations such as gas blowing or liquid quenching were executed to quickly reduce the temperature of the samples. The rapid cooling can kinetically trap some YSZ domains in their amorphous state. No grain boundaries were observed in SEM images of the cracked cross-sections of the YSZ made with this approach.

For yttrium disilicate (YDS) ceramic, all disclosed structures (e.g., complete glass electrolyte, ITS electrolyte, the sandwiched electrolyte, and the bilayer electrolyte, as shown in FIG. 2A) can be employed; however, only one example is provided hereinbelow as a proof of concept. High temperature sintering of membrane samples was conducted in an argon-filled atmosphere. The samples were sandwiched between two layers of carbon felt, and current gradually increased until the temperature of samples was higher than its melting point for seconds, followed by an immediate decrease of current to zero. Upon turning off the current supply, active cooling operations such as gas blowing or liquid quenching were executed to quickly reduce the temperature of the samples. No grain boundaries were observed in SEM images of the cracked cross-sections of the YDS made with this approach.

### Examples 4: Membranes in High-Performance Energy Storage/Conversion Devices

In some embodiments, sintered materials with at least partial glass microstructures can be used as the electrolyte layer in a high-performance energy storage/conversion device, for example, a battery having a high energy density (e.g., at least 150 W·h/kg, such as at least 200 W·h/kg). The solid-state electrolyte membranes can be, for example, glassy sodium polyaluminate for Na battery systems or LLZO for Li battery systems. Dedicated structure designs can be employed depending on the specific battery system.

In some embodiments, the cathode can act as a support layer upon which the sintered electrolyte layer can be formed. For example, the cathode layer can comprise a porous support. In some embodiments, an ion-conducting material (e.g., solid electrolyte, such as but not limited to an oxide electrolyte, NASICON or NASICON-type, LISICON, or organic electrolyte) can be added to the cathode, for example, to enhance the ion conductivity of the cathode. Alternatively or additionally, sintered layers can be stacked together and optionally subject to heat treatment (e.g., at a temperature less than the melting temperature), for example, to enhance the interface between stacked layers. Alternatively or additionally, in some embodiments, the anode can act as support layer upon which the sintered electrolyte layer can be formed. For example, the anode layer can comprise a porous support. In some embodiments, an anode material can be added to the porous support of the anode layer. In some embodiments, the cathode layer (e.g., with the ion-conducting material) and/or the electrolyte layer can be co-sintered.

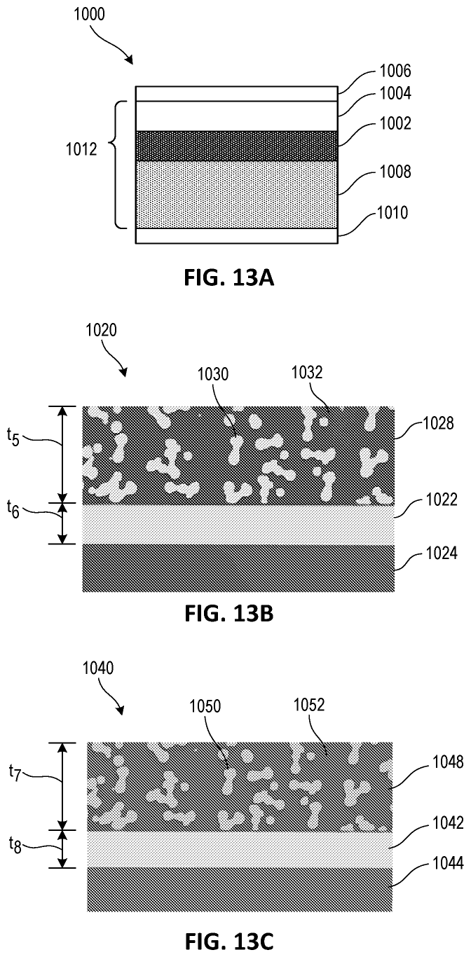

In some embodiments, the battery with electrolyte having at least partial glass microstructure can have an anode-free configuration. For example, FIG. 12A illustrates an exemplary configuration of an anode-free battery 900 (e.g., primary battery or secondary battery) that can utilize the at least partial glass microstructure material as one or more components thereof, for example, solid-state electrolyte (SSE) 902. The SSE 902 can be disposed between an anode-side current collector 906 and cathode 908 (e.g., with its own current collector 910 on a side opposite from the SSE 902). In some embodiments, the SSE 902 can be formed on the cathode 908 (or a constituent layer thereof), for example, to form internal battery assembly 904. Alternatively, in some embodiments, the cathode 908 can be formed separate from the SSE 902 and subsequently coupled thereto to form battery 900.

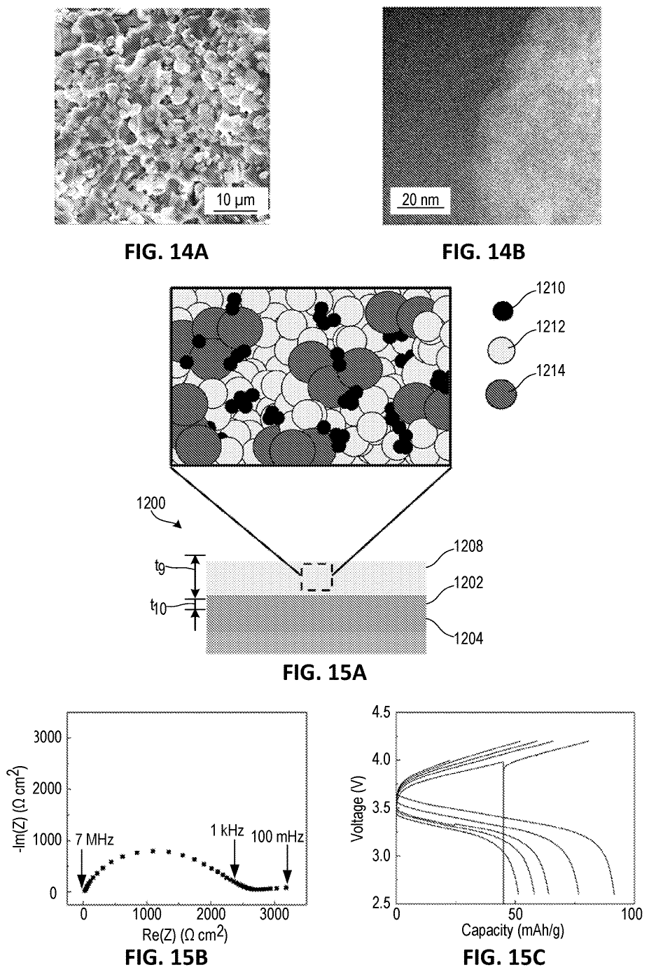

Alternatively, in some embodiments, the battery with electrolyte having at least partial glass microstructure can have a full cell configuration. For example, FIG. 13A illustrates an exemplary configuration of a full cell battery 1000 (e.g., primary battery or secondary battery) that can utilize the at least partial glass microstructure material as one of the components thereof, for example, SSE 1002. The SSE 1002 can be disposed between anode 1004 (e.g., with an anode-side current collector 1006 on a side opposite from the SSE 1002) and cathode 1008 (e.g., with a cathode-side current collector 1010 on a side opposite from the SSE 1002). In some embodiments, the SSE 1002 can be formed on the cathode 1008 (or a constituent layer thereof) and subsequently coupled to the anode 1004, for example, to form internal battery assembly 1012. Alternatively, in some embodiments, the SSE 1002 can be formed on the anode 1004 (or a constituent layer thereof) and subsequently coupled to the cathode 1008 to form the internal battery assembly. Alternatively, in some embodiments, the cathode 1008 and/or anode 1004 can be formed separate from the SSE 1002 and subsequently coupled thereto to form battery 1000.

### Example 4A: High Energy Density Li Batteries

FIG. 12B illustrates an exemplary internal assembly 920, which can be used in a Li-metal anode-free battery structure or other battery structures. The assembly 920 can have an SSE layer 922 disposed on a cathode layer 924. The SSE layer 922 can have an at least partial glass microstructure, as disclosed above. In some embodiments, the SSE layer 922 can comprise an oxide electrolyte, for example, formed of LLZO (e.g., pure glass LLZO, ITS LLZO, sandwich LLZO, or bilayer LLZO). In some embodiments, the cathode layer 924 can have a thickness t₂ in a range of 50-200 μm (e.g. 60-80 μm), and/or the SSE layer 922 can have a thickness t₁ in a range of 1-25 μm (e.g., 10-20 μm). In some embodiments, the material of the cathode layer 924 can be different and/or dissimilar from the materials of the SSE layer 922. In some embodiments, the cathode layer 924 can comprise a porous support that is not conductive with respect to Li, for example, formed of Nb₂O₅, yttria-stabilized zirconia (YSZ), or lanthanum strontium manganite (LSM). Alternatively or additionally, in some embodiments, the cathode layer 924 can comprise inorganic cathode materials and/or polymer cathode materials. For example, inorganic cathode materials (e.g., Ni-rich positive electrode materials, such as LiNiMnCoO₂ (NMC)) can be matched with a polymer electrolyte or polymer cathode material (e.g., organosulfur compound, radical compound, carbonyl compound, and/or imine compound, with some materials being subject to pre-lithiation) to function as the cathode of the cell.

For example, a bilayer structure for the assembly 920 can be achieved by tape casting and then high temperature sintering. In a fabricated example using LLZO and porous YSZ, LLZO or YSZ powders, fish oil, IPA and toluene were weighed into a jar with grinding spheres and ball-milled. After thoroughly mixing, benzyl butyl phthalate (BBP) and polyvinyl butyral (PVB) were added and milled. For the porous YSZ layer, after the ball milling process, 10 μm cross-linked PMMA spheres were added as porogens. Slurries were cast through a doctor blade onto a mylar sheet. The tapes were then laminated together by pressing to form multilayer structures, or casting YSZ layer on top of the LLZO sheet. Samples were cut from the laminated tapes and calcined in oven to remove polymers. These samples were subsequently sandwiched between two layers of carbon felt (e.g., acting as heating elements) and heated (e.g., via Joule heating) to a temperature around 50° C. above the melting point of LLZO, and then fast cooled to make ITS LLZO electrolyte on top of the porous crystalline YSZ backbone, producing the structure show in FIG. 12C. Carbon was deposited on the exposed side of the porous YSZ to enhance conductivity.

FIG. 12C illustrates another exemplary internal assembly 930, which can be used in a Li-metal anode-free battery structure or other battery structures. The assembly 930 can have an SSE layer 932 disposed on a cathode layer 934. The SSE layer 932 can have an at least partial glass microstructure, as disclosed above. In some embodiments, the SSE layer 932 can comprise an oxide electrolyte, for example, formed of LLZO (e.g., pure glass LLZO, ITS LLZO, sandwich LLZO, or bilayer LLZO). In some embodiments, the cathode layer 934 can have a thickness t₄ in a range of 50-200 μm (e.g. 60-80 μm), and/or the SSE layer 922 can have a thickness t₃ in a range of 1-25 μm (e.g., 10-20 μm). In some embodiments, the material of the cathode layer 934 can be different and/or dissimilar from the materials of the SSE layer 932. In some embodiments, the cathode layer 934 can comprise a porous support that is not conductive with respect to Li, for example, formed of Nb₂O₅, yttria-stabilized zirconia (YSZ), or lanthanum strontium manganite (LSM). Alternatively or additionally, in some embodiments, the cathode layer 924 can comprise inorganic cathode materials and/or polymer cathode materials. For example, inorganic cathode materials (e.g., Ni-rich positive electrode materials, such as LiNiMnCoO₂ (NMC)) can be matched with a polymer electrolyte or polymer cathode material (e.g., organosulfur compound, radical compound, carbonyl compound, and/or imine compound, with some materials being subject to pre-lithiation) to function as the cathode of the cell.

For example, a bilayer structure for the assembly 920 can be achieved by tape casting and then high temperature sintering. In a fabricated example using LLZO and porous YSZ, LLZO or YSZ powders, fish oil, IPA and toluene were weighed into a jar with grinding spheres and ball-milled. After thoroughly mixing, benzyl butyl phthalate (BBP) and polyvinyl butyral (PVB) were added and milled. For the porous YSZ layer, after the ball milling process, 10 μm cross-linked PMMA spheres were added as porogens. Slurries were cast through a doctor blade onto a mylar sheet. The tapes were then laminated together by pressing to form multilayer structures, or casting YSZ layer on top of the LLZO sheet. Samples were cut from the laminated tapes and calcined in oven to remove polymers. These samples were subsequently sandwiched between two layers of carbon felt (e.g., acting as heating elements) and heated (e.g., via Joule heating) to a temperature around 50° C. above the melting point of LLZO, and then fast cooled to make ITS LLZO electrolyte on top of the porous crystalline YSZ backbone, producing the structure shown in FIG. 12C. Carbon was deposited on the exposed side of the porous YSZ to enhance conductivity. Another fabricated example using LLZO and porous LSM is shown in FIG. 12D.

### Example 4B: High Energy Density Na Batteries

FIG. 12E illustrates an exemplary internal assembly 930 for use in a Na-metal anode-free battery structure or other battery structures. The assembly 930 can have an SSE layer 932 disposed on a cathode layer 934. The SSE layer 932 can have an at least partial glass microstructure, as disclosed above. In some embodiments, the SSE layer 932 can comprise an oxide electrolyte, for example, formed of glassy sodium polyaluminate (e.g., pure glass sodium polyaluminate, ITS sodium polyaluminate, sandwich sodium polyaluminate, or bilayer sodium polyaluminate). In some embodiments, the cathode layer 934 can have a thickness t₄ in a range of 50-200 μm (e.g., 60-80 μm), and/or the SSE layer 932 can have a thickness t₃ in a range of 1-25 μm (e.g., 10-20 μm). In some embodiments, the material of the cathode layer 934 can be different and/or dissimilar from the materials of the SSE layer 932. In some embodiments, the cathode layer 934 can comprise a porous support that is not conductive with respect to Na, for example, formed of YSZ. Alternatively or additionally, in some embodiments, the cathode layer 934 can comprise inorganic cathode materials and/or polymer cathode materials. For example, the inorganic cathode materials (e.g., Ni-rich positive electrode materials, such as Na_{0.66}Ni_{0.33}Mn_{0.67}O₂ and NMC) can be matched with a polymer electrolyte or polymer cathode material (e.g., organosulfur compound and/or imine compound, with some materials being subject to pre-sodiation) to function as the cathode of the cell.

### Example 4C: Solid-State Na-Ion Battery with Oxide Electrolyte in Cathode

FIG. 13B illustrates an exemplary internal battery assembly 1020 for use in a Na-ion battery structure. The assembly 1020 can have an SSE layer 1022 disposed between an anode layer 1024 and a cathode layer 1028. The anode layer 1024 can comprise Na metal or Na—Sn alloy (e.g., having an Sn ratio of 20-80 wt %, inclusive). The SSE layer 1022 can have an at least partial glass microstructure, as disclosed above. In some embodiments, the SSE layer 1022 can comprise an oxide electrolyte, for example, formed of glassy sodium polyaluminate (e.g., pure glass sodium polyaluminate, ITS sodium polyaluminate, sandwich sodium polyaluminate, or bilayer sodium polyaluminate). In some embodiments, the cathode layer 1028 can have a thickness t₅ in a range of 50-500 μm (e.g., 50-200 μm), and/or the SSE layer 1022 can have a thickness t₆ less than 25 μm (e.g., 10-20 μm). In some embodiments, the cathode layer 1028 can include one or more cathode materials 1032 with one or more oxide electrolytes 1030. In some embodiments, the cathode layer 1028 can further include a carbon additive, for example, carbon black. In some embodiments, the oxide electrolytes 1030 can be co-sintered with the cathode materials 1032 to form a monolithic layer. In some embodiments, the oxide electrolyte 1030 included in the cathode layer 1028 can be the same as or different from the material of the SSE layer 1022. For example, the oxide electrolyte 1030 can comprise glassy sodium polyaluminate, beta-alumina, or combinations thereof. In some embodiments, the Na metal battery may be configured for use as a relatively low-cost option and/or for applications requiring lower energy densities, for example, to store electricity for the electrical grid.

For sodium batteries, cathode materials were selected (e.g., Na_{0.66}Ni_{0.33}Mn_{0.67}O₂ or Na₃V₂(PO₄)₃) and co-sintered with the beta-alumina electrolyte/carbon powders to form a composite cathode layer, as shown in FIG. 13B. Together with Na—Sn alloy, an all-solid-state sodium metal battery structure can be achieved. The bilayer structure for the SSE and cathode support can be achieved by tape casting and then high temperature sintering. The beta-alumina powders, fish oil, IPA, and toluene were weighed into a jar with grinding spheres and ball-milled. After thoroughly mixing, benzyl butyl phthalate (BBP) and polyvinyl butyral (PVB) were added and milled. For the beta-alumina/cathode layer, cathode materials, carbon, and beta-alumina powders were mixed and dispersed with IPA and ball milled to form slurries. Slurries were cast through a doctor blade onto a mylar sheet. The tapes were then laminated together by pressing to form multilayer structures. Samples were cut from the laminated tapes and calcined in oven to remove polymers.

High temperature sintering of membrane samples by electrical Joule heating was conducted in an argon-filled atmosphere. The samples were sandwiched between two layers of carbon felt (acting as heating elements), and the current was gradually increased until the temperature of samples becomes 10-200° C. higher than its melting point for seconds, followed by an immediate decrease of current to zero. Upon turning off the current supply, active cooling operations such as gas blowing or liquid quenching were performed to rapidly reduce the temperature of the samples. The Na/Sn anode pieces were attached to the plane side of the beta-alumina electrolyte to assemble the full cell.

### Example 4D: Solid-State Na-Ion Battery with Non-Oxide Electrolyte in Cathode

FIG. 13C illustrates an exemplary internal battery assembly 1040 for use in a Na-ion battery structure. The assembly 1040 can have an SSE layer 1042 disposed between an anode layer 1044 and a cathode layer 1048. The anode layer 1044 can comprise Na metal or Na—Sn alloy (e.g., having an Sn ratio of 20-80 wt %, inclusive). The SSE layer 1042 can have an at least partial glass microstructure, as disclosed above. In some embodiments, the SSE layer 1042 can comprise an oxide electrolyte, for example, formed of glassy sodium polyaluminate (e.g., pure glass sodium polyaluminate, ITS sodium polyaluminate, sandwich sodium polyaluminate, or bilayer sodium polyaluminate). In some embodiments, the cathode layer 1048 can have a thickness t₇ in a range of 50-500 μm (e.g., 50-200 μm), and/or the SSE layer 1042 can have a thickness t₈ less than 25 μm (e.g., 10-20 μm). In some embodiments, the cathode layer 1048 can include one or more cathode materials 1052 with one or more non-oxide electrolytes 1050 (e.g., a halide electrolyte or sulfide electrolyte). In some embodiments, the cathode layer 1048 can further include carbon particles, for example, carbon black. In some embodiments, the non-oxide electrolytes 1050 can be mixed and hot-pressed (e.g., at a temperature less than the material's melting temperature) with the cathode materials 1052 to form a monolithic layer. In some embodiments, the non-oxide electrolyte 1050 included in the cathode layer 1048 can be the same as or different from the material of the SSE layer 1042. For example, the non-oxide electrolyte 1050 can comprise Na—P—S—Cl or Na—Sn—P—S. In some embodiments, the Na metal battery may be configured for use as a relatively low-cost option and/or for applications requiring lower energy densities, for example, to store electricity for the electrical grid.

To decrease the cathode manufacturing temperature, non-oxide SSE electrolyte powders (e.g., Na—Sn—P—S) were mixed with cathode materials (e.g., Na_{0.66}Ni_{0.33}Mn_{0.67}O₂ or Na₃V₂(PO₄)₃) and subsequently hot pressed at a temperature of ~200° C. Owing to the good fluidity of the sulfide-based electrolyte, the cathode interface can be resolved without needing a co-sintering process. Na metal or Na—Sn alloy (Sn ratio: 20-80 wt %) were employed to function as the anode. Other low melting-point electrolyte compositions, such as but not limited to Na—P—S—Cl or Na—Sn—Sb—S, can also be used here, for example, to hot press with the cathode materials to address the cathode-electrolyte interface issue.

The bilayer structure for the SSE can be achieved by tape casting and then high temperature sintering. In a fabricated example, beta-alumina powders, fish oil, IPA, and toluene were weighed into a jar with grinding spheres and ball-milled. After thoroughly mixing, benzyl butyl phthalate (BBP) and polyvinyl butyral (PVB) were added and milled. For the cathode layer, cathode materials, carbon, and low melting-point electrolyte compositions (e.g., Na—P—S—Cl or Na—Sn—Sb—S) were mixed and dispersed with IPA and ball milled to form slurries. Slurries were cast through a doctor blade onto a mylar sheet. The tapes were then laminated together by pressing to form multilayer structures. Samples were cut from the laminated tapes and calcined in oven with argon-atmosphere to remove polymers.

High temperature sintering of membrane samples by electrical Joule heating was conducted in an argon-filled atmosphere. The samples were sandwiched between two layers of carbon felt (acting as heating elements), and the current was gradually increased until the temperature of samples became 10-200° C. higher than its melting point for seconds, followed by an immediate decrease of current to zero. Upon turning off the current supply, active cooling operations, such as gas blowing or liquid quenching, were performed to rapidly reduce the temperature of the samples. The Na/Sn anode pieces were attached to the exposed side of the beta alumina electrolyte to assemble the full cell.

### Example 5: Rapid Co-Sintering of Cathode Materials with Electrolytes

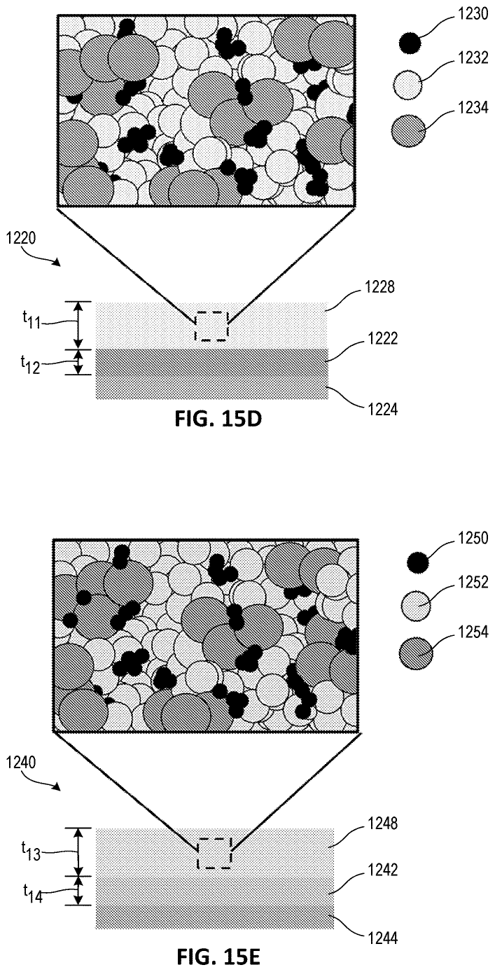

Carbon felt heaters were used to effect rapid co-sintering of the cathode materials (e.g., NMC) with oxide electrolytes (e.g., LLZO). For example, FIGS. 14A-14B show cross-sectional SEM and STEM images, respectively, of the NMC and LLZO co-sintered together. The heating temperature was around 1400° C. for 3 seconds. Due to mass thickness contrast, the dark phase in the figures corresponds to NMC, while the bright phase corresponds to LLZO. As is apparent from FIGS. 11A-11B, a good interface was formed between NMC and LLZO with a very thin interface region (~10 nm), which is good for impedance reduction.

### Examples 6: Solid-State Battery with Oxide SSE and Cathode with Non-Oxide SSE

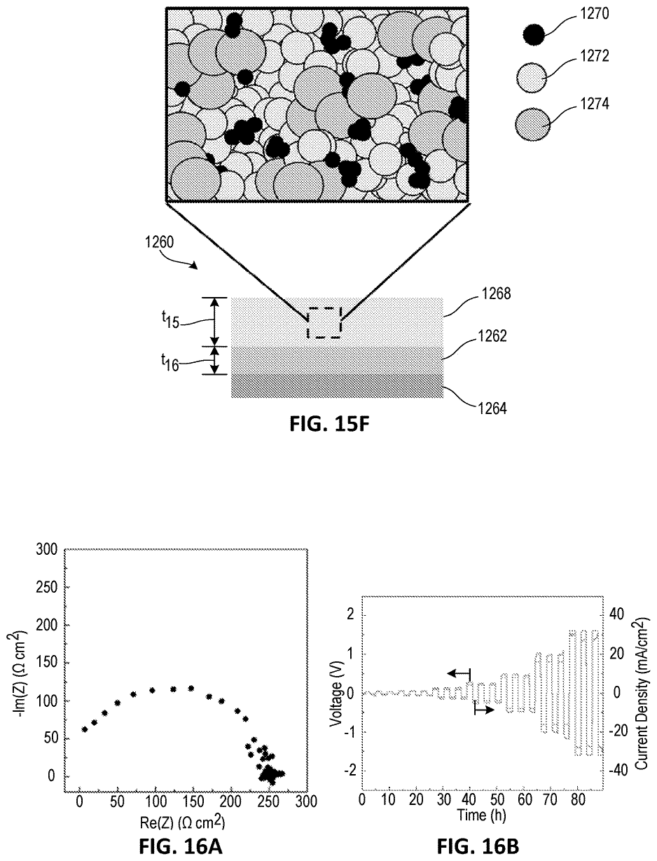

As-synthesized electrolytes can be incorporated into a variety of all solid-state battery devices. In addition to the co-sintering methods mentioned above, FIGS. 15A and 15D-15F illustrate detailed structure schematics for all-solid-state full cell cases in which the cathodes are composites with non-oxide SSEs that are softer than oxide SSE. For example, the softer non-oxide SSEs may be able to better accommodate the volume changes of cathode particles induced by battery cycling. In some embodiments, the softer non-oxide SSEs can have a Young's modulus less than or equal to 50 GPa, for example, approximately 20 GPa.

In some embodiments, a non-oxide Na SSE incorporated in a cathode can be a sulfide SSE, a halide SSE, a NASICON SSE, or a polymer SSE. For example, the sulfide SSEs can include, but are not limited to, (a) Na₃PS₄; (b) Na₃SbS₄; (c) Na₃PSe₄; (d) Na₁₁Sn₂PS₁₂; (e) Na₁₁Sn₂SbS₁₂; and (f) Na₃P_{0.62}As_{0.38}S₄. For example, the halide SSEs can include, but are not limited to, (a) Na₂S—P₂S₅—NaX, where X is one or more of F, Cl, Br, I, At, and Ts; and (b) Na₃OX, where X is one or more of F, Cl, Br, I, At, and Ts. For example, the NASICON SSE can be Na₃Zr₂Si₂PO₁₂. For example, the polymer SSEs can include, but are not limited to, PEO-NaClO₄ and PEO-NaPF₆.

In some embodiments, a non-oxide Li SSE incorporated in a cathode can be a sulfide SSE, a halide SSE, or a NASICON-type SSE. For example, the halide SSEs can include, but are not limited to, (a) Li₂S—P₂S₅—LiX, where X is one or more of F, Cl, Br, I, At, and Ts; (b) Li₃MCl6, where M is one or more of Y, In, Sc and Ho; (c) Li₃OX, where X is one or more of F, Cl, Br, I, At, and Ts; (d) LiₓTa_{y}La_{z}Cl₃, where x, y, and z are numbers; and (e) LiₐP_{b}S_{c}Cl, where a, b, and c are numbers. For example, the sulfide SSEs can include, but are not limited to, (a) Li₂S—P₂S₅ (LPS); (b) Li₁₀GeP₂S₁₂ (LGPS); (c) Li₁₀SnP₂S₁₂; and (d) Li₁₀SiP₂S₁₂. For example, the NASICON-type SSEs can include, but are not limited to, (a) Li_{1.5}Al_{0.5}Ti_{1.5}(PO₄)₃ (LATP); (b) Li₁₊ₓAlₓGe₂₋ₓ(PO₄)₃ (LAGP); and (c) Li₁₄Zn(GeO₄)₄ (LISICON).

### Example 6A: All-Solid-State Full Cell with Sulfide-Solid-Electrolyte-Containing Cathode

FIG. 15A illustrates an exemplary internal battery assembly 1200 for use in a Li-ion battery structure. The assembly 1200 can have an SSE layer 1202 disposed between an anode layer 1204 and a cathode layer 1208. For example, the anode layer 1204 can comprise Li metal. The SSE layer 1202 can have an at least partial glass microstructure, as disclosed above. In some embodiments, the SSE layer 1202 can comprise an oxide electrolyte, for example, LLZO. In some embodiments, the cathode layer 1208 can have a thickness t₉ in a range of 50-200 μm, and/or the SSE layer 1202 can have a thickness t₁₁ in a range of 1-20 μm, for example, ~10 μm. In some embodiments, the cathode layer 1208 can be a composite of one or more cathode materials 1212 (e.g., lithium nickel manganese cobalt oxides (NMC)) and one or more solid-state electrolytes 1214 (e.g., Li₁₀GeP₂S (LGPS), Li₆PS₅Cl (LPSCl, Argyrodite)). In some embodiments, the cathode layer 1208 can further include carbon additives (e.g., particles) 1210, for example, carbon black.

The electrolyte layer 1202 can be a glassy, ITS, sandwiched, or bilayer LLZO solid electrolyte, depending on the desired properties. Li metal can be utilized as an anode material 1204, which can offer a high theoretical capacity and low electrochemical potential. For the cathode part, a hot-pressed (e.g., warm isostatic pressed) composite can be employed. For example, the cathode composite can include a mixture of a non-oxide soft solid-state electrolyte powders (e.g., LPSCl), a conducting carbon additive for enhanced electronic conductivity (e.g., carbon black), and NMC. To increase performance and reduce interfacial impedance, the cathode composite can be hot-pressed together with the electrolyte. This process can promote the formation of a strong and intimate interface, which may be helpful for efficient charge transfer and overall battery performance. The EIS result (FIG. 15B) and charging/discharging curves (FIG. 15C) for this type of all-solid-state battery confirm the feasibility of this device structure. For example, the cell can be successfully cycled with a wide potential window from 2.6 V to 4.2 V and an initial discharging capacity close to 100 mAh/g, as shown in FIG. 15C.

### Example 6B: All-Solid-State Full Cell with Halide-Solid-Electrolyte-Containing Cathode

FIG. 15D illustrates an exemplary internal battery assembly 1220 for use in a Li-ion battery structure. The assembly 1220 can have an SSE layer 1222 disposed between an anode layer 1224 and a cathode layer 1228. For example, the anode layer 1224 can comprise Li metal. The SSE layer 1222 can have an at least partial glass microstructure, as disclosed above. In some embodiments, the SSE layer 1222 can comprise an oxide electrolyte, for example, LLZO. In some embodiments, the cathode layer 1228 can have a thickness t₁₁ in a range of 50-200 μm, and/or the SSE layer 1222 can have a thickness t₁₂ in a range of 1-20 μm, for example, ~10 μm. In some embodiments, the cathode layer 1228 can be a composite of one or more cathode materials 1232 (e.g., NMC) and one or more halide electrolytes 1234 (e.g., Li—P—S—Cl or Li₃YCl₆). In some embodiments, the cathode layer 1228 can further include carbon additives (e.g., particles) 1230, for example, carbon black.

The electrolyte layer 1222 can be a glassy, ITS, sandwiched, or bilayer LLZO solid electrolyte, depending on the desired properties. Li metal can be utilized as an anode material 1224, which can offer a high theoretical capacity and low electrochemical potential. For the cathode part, a composite can be employed. For example, the cathode composite can include a mixture of a non-oxide halide solid-state electrolyte powders, a conducting carbon additive for enhanced electronic conductivity (e.g., carbon black), and NMC. To increase performance and reduce the interfacial impedance, the cathode composite can be hot-pressed together with the electrolyte. This process can promote the formation of a strong and intimate interface, which may be helpful for efficient charge transfer and overall battery performance.

### Example 6C: All-Solid-State Na-Ion Full Cell with Sulfide-Solid-Electrolyte-Containing Cathode

FIG. 15E illustrates an exemplary internal battery assembly 1240 for use in a Na-ion battery structure. The assembly 1240 can have an SSE layer 1242 disposed between an anode layer 1244 and a cathode layer 1248. For example, the anode layer 1244 can comprise Na metal or Na/Sn alloy (e.g., Sn ratio in a range of about 5-20 wt %, inclusive). The SSE layer 1242 can have an at least partial glass microstructure, as disclosed above. In some embodiments, the SSE layer 1242 can comprise an oxide electrolyte, for example, glassy sodium polyaluminate. In some embodiments, the cathode layer 1248 can have a thickness t₁₃ in a range of 50-200 μm, and/or the SSE layer 1242 can have a thickness t₁₄ in a range of 1-20 μm, for example, ~10 μm. In some embodiments, the cathode layer 1248 can be a composite of one or more cathode materials 1252 (e.g., NVP or Na—Mn—Fe—Ni—O (e.g., NaMn_{0.33}Fe_{0.33}Ni_{0.33}O₂)) and one or more sulfide electrolytes 1254 (e.g., Na—Sn—P—S). In some embodiments, the cathode layer 1248 can further include carbon additives (e.g., particles) 1250, for example, carbon black.

The electrolyte layer 1242 can either be a glassy, ITS, sandwiched, or bilayer glassy sodium polyaluminate solid electrolyte, depending on the desired properties. Sodium metal alloy (e.g., Na—Sn alloy) can be utilized as an anode material, which can offer a high theoretical capacity and low electrochemical potential. For the cathode part, a hot-pressed composite can be employed. For example, the cathode composite can include a mixture of a non-oxide solid-state electrolyte powder (e.g., Na—Sn—P—S), a conducting carbon additive for enhanced electronic conductivity (e.g., carbon black), and Na—Mn—Fe—Ni—O. To increase performance and reduce the interfacial impedance, the cathode composite can be hot-pressed together with the electrolyte. This process promotes the formation of a strong and intimate interface, which may be helpful for efficient charge transfer and overall battery performance.

### Example 6D: All-Solid-State Na-Ion Full Cell with Halide-Solid-Electrolyte-Containing Cathode

FIG. 15F illustrates an exemplary internal battery assembly 1260 for use in a Na-ion battery structure. The assembly 1260 can have an SSE layer 1262 disposed between an anode layer 1264 and a cathode layer 1268. For example, the anode layer 1264 can comprise Na metal or Na/Sn alloy (e.g., Sn ratio in a range of about 5-20 wt %, inclusive). The SSE layer 1262 can have an at least partial glass microstructure, as disclosed above. In some embodiments, the SSE layer 1262 can comprise an oxide electrolyte, for example, glassy sodium polyaluminate. In some embodiments, the cathode layer 1268 can have a thickness t₁₅ in a range of 50-200 μm, and/or the SSE layer 1262 can have a thickness t₁₆ in a range of 1-20 μm, for example, ~10 μm. In some embodiments, the cathode layer 1268 can be a composite of one or more cathode materials 1272 (e.g., NVP or Na—Mn—Fe—Ni—O (e.g., NaMn_{0.33}Fe_{0.33}Ni_{0.33}O₂)) and one or more halide electrolytes 1274 (e.g., Na—P—S—Cl or Na—Y—Zr—Cl). In some embodiments, the cathode layer 1268 can further include carbon additives (e.g., particles) 1270, for example, carbon black.

The electrolyte layer 1262 can either be a glassy, ITS, sandwiched, or bilayer sodium polyaluminate solid electrolyte, depending on the desired properties. Sodium metal alloy (e.g., Na—Sn alloy) can be utilized as an anode material, which can offer a high theoretical capacity and low electrochemical potential. For the cathode part, a hot-pressed composite can be employed. For example, the cathode composite can include a mixture of a non-oxide solid-state electrolyte powders (e.g., Na—Y—Zr—Cl), a conducting carbon additive for enhanced electronic conductivity (e.g., carbon black), and Na—Mn—Fe—Ni—O. To increase performance and reduce the interfacial impedance, the cathode composite can be hot-pressed together with the electrolyte. This process promotes the formation of a strong and intimate interface, which may be helpful for efficient charge transfer and overall battery performance.

### Example 7: Electrochemical Evaluation of Electrolytes

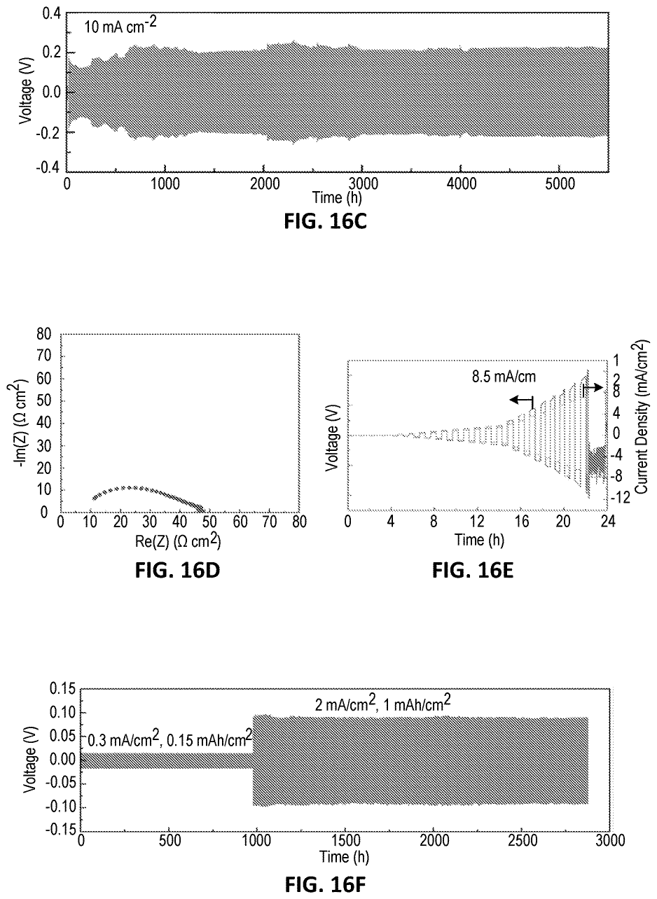

To electrochemically evaluate the LLZO electrolyte, a thin layer (around 60 nm) of zinc oxide (ZnO) was deposited on both sides of ITS LLZO pellets by atomic layer deposition to negate interfacial impedance. The resulting solid-state electrolyte was sandwiched between two lithium metal electrodes. As shown by the EIS testing results of FIGS. 16A-16B, the impedance of symmetric batteries with ITS LLZO is similar to that of conventional garnet electrolyte (ASR of ~250 Ω-cm² and conductivity of ~4×10⁻⁴ S/cm). Furthermore, due to the suppression of lithium dendrite growth, the critical current density (CCD) of the fabricated battery was an order of magnitude higher (FIG. 16B, ~16 mA/cm²) than values for existing solid-state LLZO batteries (~1 mA/cm²). As shown in FIG. 16C, the symmetric cells can be cycled at a high current density of 10 mA/cm² for more than 5000 hours, confirming its long-term stability.

Symmetric cell testing was also used to evaluate sandwiched alumina electrolytes (e.g., glassy sodium polyaluminate between layers of beta-alumina). Opposite sides of the sandwiched alumina electrolyte were attached to respective Na—Sn alloy electrodes (with the Sn serving to negate, or at least reduce, interface impedance). As shown by the EIS test results of FIG. 16D, the impedance of symmetric batteries with sandwiched alumina electrolyte is similar to that of conventional beta-alumina electrolyte (ASR of ~50 Ω-cm² and conductivity of ~2×10⁻³ S/cm). Furthermore, due to the suppression of lithium dendrite growth, the CCD of the fabricated battery was much higher (FIG. 16E, ~8.5 mA/cm² at room temperature) than values for existing beta-alumina solid-state batteries (~0.75 mA/cm² at room temperature). As shown in FIG. 16F, the symmetric cells can be cycled at a high current density of 2 mA/cm² for more than 1000 hours, confirming its long-term stability.

Compared with other solid-state electrolytes, embodiments of the disclosed subject matter offer the advantages of facile preparation, low cost, and the ability of creating high energy density batteries.

### Example 8: Textured Beta-Alumina

A beta-alumina electrolyte was synthesized via a solid-state reaction method. Precursors were stoichiometrically mixed and then ball milled. The mixed powders were then calcined in air. Membranes were prepared by tape-casting or a mold-pressing of the calcined powders. High temperature sintering of the beta-alumina membrane samples was performed by electrical Joule heating in an argon-filled atmosphere using the configuration shown in FIG. 3C. In particular, a membrane sample (10-mm diameter, 0.6-mm thick) was placed between two layers of carbon felt acting as separate heating elements. Heating of the carbon felt was independently controlled by separate power supplies, such that a fixed power difference (e.g., 200-500 W) was maintained between the heaters. The power applied to each carbon felt was gradually increased (about 200 W/s) with the fixed power difference to a maximum level and sustained for a few seconds (10-15 seconds), followed by a decrease of power to zero. A thermal gradient was thus established across a thickness of the membrane sample due to temperature difference (e.g., 100-150° C.) between the two heaters (which, in turn, was a function of the power difference).

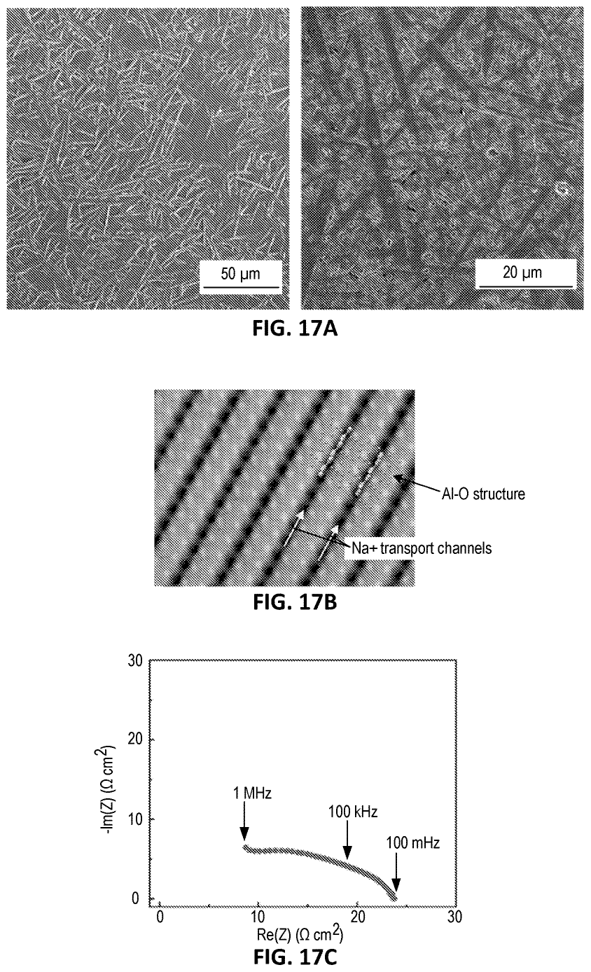

After the sintering, the grains of beta-alumina become needle-like due to thermal gradient, and they are aligned in the direction perpendicular to the top and bottom surfaces of the pellet samples, as shown in FIG. 17A. As shown in FIG. 17B, the Na conducting planes are grown along the long end of grains. This structure with needle morphology and alignment results in much shorter sodium transporting distance, and thus the Na+ ion conductivity has been improved to 4.4 mS/cm (area impedance of 24 Ohm/cm²), as shown in the EIS result of FIG. 17C, which conductivity is higher than that for conventional beta-alumina materials (e.g., 1-2 mS/cm) and other ceramic-based sodium electrolytes.

### Additional Examples of the Disclosed Technology

In view of the above-described implementations of the disclosed subject matter, this application discloses the additional examples in the clauses enumerated below. It should be noted that one feature of a clause in isolation, or more than one feature of the clause taken in combination, and, optionally, in combination with one or more features of one or more further clauses are further examples also falling within the disclosure of this application.

Clause 1. A structure comprising:
a solid-state ion-conducting layer,
wherein at least a portion of the solid-state ion-conducting layer is in a glass phase, or
the solid-state ion-conducting layer comprises a polycrystalline ceramic having crystal grains substantially aligned with respect to a common direction.

Clause 2. The structure of any clause or example herein, in particular, Clause 1, wherein an entirety of the solid-state ion-conducting layer has a single chemical composition and is in the glass phase.

Clause 3. The structure of any clause or example herein, in particular, Clause 1, wherein the solid-state ion-conducting layer comprises one or more crystalline portions embedded within and surrounded by the glass phase, and each portion of the solid-state ion-conducting layer has a same chemical composition.

Clause 4. The structure of any clause or example herein, in particular, Clause 1, wherein:
the solid-state ion-conducting layer comprises a first sublayer in the glass phase, a second sublayer in the glass phase, and a polycrystalline sublayer between the first and second sublayers; and
each portion of the first sublayer, the second sublayer, and the polycrystalline sublayer has a same chemical composition.

Clause 5. The structure of any clause or example herein, in particular, Clause 4, wherein the first and second sublayers are outermost portions on opposite ends of the solid-state ion-conducting layer along a thickness direction thereof.

Clause 6. The structure of any clause or example herein, in particular, Clause 1, wherein:
the solid-state ion-conducting layer comprises a glass-phase sublayer and a polycrystalline sublayer adjacent to the glass-phase sublayer; and
each portion of the glass-phase sublayer and the polycrystalline sublayer has a same chemical composition.

Clause 7. The structure of any clause or example herein, in particular, any one of Clauses 1-6, wherein the solid-state ion-conducting layer is an oxide and has an ion conductivity of at least 10⁻⁴ S/cm.

Clause 8. The structure of any clause or example herein, in particular, any one of Clauses 1-7, wherein the solid-state ion-conducting layer is constructed as a solid-state electrolyte for a battery.

Clause 9. The structure of any clause or example herein, in particular, any one of Clauses 1-8, wherein the solid-state ion-conducting layer is constructed to conduct alkali metal ions, anions, or both.

Clause 10. The structure of any clause or example herein, in particular, any one of Clauses 1-9, wherein the solid-state ion-conducting layer is constructed to conduct lithium ions, sodium ions, potassium ions, oxygen ions, or any combination of the foregoing.

Clause 11. The structure of any clause or example herein, in particular, any one of Clauses 1-10, wherein the solid-state ion-conducting layer comprises (i) lithium lanthanum zirconate (LLZO), (ii) beta-alumina, (iii) sodium polyaluminate, (iv) yttria-stabilized zirconia (YSZ), (v) yttrium monosilicate (YMS), or (vi) yttrium disilicate (YDS).

Clause 12. The structure of any clause or example herein, in particular, Clause 1, wherein the crystal grains of the polycrystalline ceramic are aligned with respect to a thickness of the solid-state ion-conducting layer.

Clause 13. The structure of any clause or example herein, in particular, any one of Clauses 1 and 12, wherein the crystal grains of the polycrystalline ceramic are needle-like in shape.

Clause 14. The structure of any clause or example herein, in particular, any one of Clauses 1, 12, and 13, wherein ion conducting planes are along long ends of the crystal grains of the polycrystalline ceramic.

Clause 15. A battery comprising:
a cathode; and
a solid-state electrolyte coupled to the cathode, the solid-state electrolyte comprising the solid-state ion-conducting structure of any clause or example herein, in particular, any one of Clauses 1-14.

Clause 16. The battery of any clause or example herein, in particular, Clause 15, further comprising an anode coupled to the solid-state electrolyte and disposed on a side of the solid-state electrolyte opposite from the cathode.

Clause 17. The battery of any clause or example herein, in particular, Clause 16, wherein the anode is a lithium anode.

Clause 18. The battery of any clause or example herein, in particular, any one of Clauses 16-17, wherein the anode consists essentially of lithium.

Clause 19. The battery of any clause or example herein, in particular, Clause 15, wherein the battery has an anode-free configuration.

Clause 20. The battery of any clause or example herein, in particular, any one of Clauses 15-19, wherein the cathode comprises a Ni-rich positive electrode material.

Clause 21. The battery of any clause or example herein, in particular, any one of Clauses 15-20, wherein the cathode comprises lithium nickel manganese cobalt oxide (LiNiMnCoO₂) or nickel manganese cobalt (NMC).

Clause 22. The battery of any clause or example herein, in particular, any one of Clauses 15-21, wherein the cathode comprises a non-Li-conductive porous support.

Clause 23. The battery of any clause or example herein, in particular, Clause 22, wherein the non-Li-conductive porous support comprises niobium pentoxide (Nb₂O₅), yttria-stabilized zirconia (YSZ), or lanthanum strontium manganite (LSM).

Clause 24. The battery of any clause or example herein, in particular, any one of Clauses 22-23, wherein the cathode comprises a polymer cathode material.

Clause 25. The battery of any clause or example herein, in particular, Clause 24, wherein the polymer cathode material comprises an organosulfur compound, a radical compound, a carbonyl compound, or an imine compound.

Clause 26. The battery of any clause or example herein, in particular, any one of Clauses 15-25, wherein the cathode comprises a non-oxide lithium ion conductor.

Clause 27. The battery of any clause or example herein, in particular, Clause 26, wherein the non-oxide lithium ion conductor has a Young's modulus less than or equal to 50 GPa.

Clause 28. The battery of any clause or example herein, in particular, any one of Clauses 26-27, wherein the non-oxide lithium ion conductor is a halide solid electrolyte or sulfide solid electrolyte.

Clause 29. The battery of any clause or example herein, in particular, Clause 28, wherein:
the halide solid electrolyte comprises (a) Li₂S—P₂S₅—LiX, where X is one or more of F, Cl, Br, I, At, and Ts, (b) Li₃MCl₆, where M is one or more of Y, In, Sc and Ho, (c) Li₃OX, where X is one or more of F, Cl, Br, I, At, and Ts, and/or (d) LiₓTa_{y}La_{z}Cl₃, where x, y, and z are numbers; or
the sulfide solid electrolyte comprises (a) Li₂S—P₂S₅ (LPS), (b) Li₁₀GeP₂S₁₂ (LGPS), (c) Li₁₀SnP₂S₁₂, and/or (d) Li₁₀SiP₂S₁₂.

Clause 30. The battery of any clause or example herein, in particular, any one of Clauses 26-27, wherein the non-oxide lithium ion conductor is a NASICON-type electrolyte.

Clause 31. The battery of any clause or example herein, in particular, Clause 30, wherein the NASICON-type electrolyte comprises (a) Li_{1.5}Al_{0.5}Ti_{1.5}(PO₄)₃ (LATP), (b) Li₁₊ₓAlₓGe₂₋ₓ(PO₄)₃ (LAGP), or (c) Li₁₄Zn(GeO₄)₄ (LISICON).

Clause 32. The battery of any clause or example herein, in particular, any one of Clauses 15-31, wherein the cathode comprises beta-alumina, glassy sodium polyaluminate, or both.

Clause 33. The battery of any clause or example herein, in particular, any one of Clauses 15-32, wherein the solid-state electrolyte has a thickness less than or equal to 25 μm and/or the cathode has a thickness in range of 50-200 μm, inclusive.

Clause 34. The battery of any clause or example herein, in particular, Clause 16, wherein the anode comprises Na or an Na—Sn alloy.

Clause 35. The battery of any clause or example herein, in particular, any one of Clauses 16 and 34, wherein the cathode comprises Na_{0.66}Ni_{0.33}Mn_{0.67}O₂ (NNM), sodium vanadium phosphate (NVP), or NaMnFeNiO.

Clause 36. The battery of any clause or example herein, in particular, any one of Clauses 34-35, wherein the cathode comprises a Ni-rich positive electrode material.

Clause 37. The battery of any clause or example herein, in particular, any one of Clauses 34-36, wherein the cathode comprises nickel manganese cobalt (NMC).

Clause 38. The battery of any clause or example herein, in particular, any one of Clauses 34-37, wherein the cathode comprises a non-Na-conductive porous support.

Clause 39. The battery of any clause or example herein, in particular, Clause 38, wherein the non-Na-conductive porous support comprises yttria-stabilized zirconia (YSZ).

Clause 40. The battery of any clause or example herein, in particular, any one of Clauses 34-38, wherein the cathode comprises a polymer cathode material.

Clause 41. The battery of any clause or example herein, in particular, Clause 40, wherein the polymer cathode material comprises an organosulfur compound or an imine compound.

Clause 42. The battery of any clause or example herein, in particular, any one of Clauses 15 and 34-41, wherein the cathode comprises a non-oxide sodium ion conductor.

Clause 43. The battery of any clause or example herein, in particular, Clause 42, wherein the non-oxide sodium ion conductor has a Young's modulus less than or equal to 50 GPa.

Clause 44. The battery of any clause or example herein, in particular, any one of Clauses 42-43, wherein the non-oxide sodium ion conductor is a halide solid electrolyte or sulfide solid electrolyte.

Clause 45. The battery of any clause or example herein, in particular, Clause 44, wherein:
the halide solid electrolyte comprises (a) Na₂S—P₂S₅—NaX, where X is one or more of F, Cl, Br, I, At, and Ts, (b) Na₃OX, where X is one or more of F, Cl, Br, I, At, and Ts, and/or (c) Na—Y—Zr—Cl; or
the sulfide solid electrolyte comprises (a) Na₃PS₄; (b) Na₃SbS₄; (c) Na₃PSe₄; (d) Na₁₁Sn₂PS₁₂; (e) Na₁₁Sn₂SbS₁₂; (f) Na₃P_{0.62}As_{0.38}S₄, and/or (g) Na—P—S—Cl.

Clause 46. The battery of any clause or example herein, in particular, any one of Clauses 42-45, wherein the non-oxide sodium ion conductor is a NASICON electrolyte.

Clause 47. The battery of any clause or example herein, in particular, any one of Clauses 42-46, wherein the non-oxide sodium ion conductor comprises a polymer electrolyte.

Clause 48. The battery of any clause or example herein, in particular, Clause 47, wherein the polymer electrolyte comprises polyethylene oxide (PEO) and one of NaClO₄ and NaPF₆.

Clause 49. The battery of any clause or example herein, in particular, any one of Clauses 15-48, wherein the cathode comprises beta-alumina, glassy sodium polyaluminate, or both.

Clause 50. The battery of any clause or example herein, in particular, any one of Clauses 15-49, wherein the solid-state electrolyte has a thickness in a range of 10-20 μm, inclusive, and/or the cathode has a thickness in range of 50-500 μm, inclusive.

Clause 51. The battery of any clause or example herein, in particular, any one of Clauses 15-50, wherein the cathode is a composite comprising (i) a cathode material and (ii) a non-oxide halide solid electrolyte, a non-oxide sulfide solid electrolyte, or beta-alumina.

Clause 52. The battery of any clause or example herein, in particular, Clause 51, wherein the non-oxide electrolyte comprises NaPSCl, NaSnPS, LGPS, NMC, LPSCl, or any combination thereof.

Clause 53. The battery of any clause or example herein, in particular, any one of Clauses 51-52, where the cathode composite further comprises carbon particles.

Clause 54. The battery of any clause or example herein, in particular, Clause 53, wherein the carbon particles of the cathode composite are carbon black.

Clause 55. A method comprising:
subjecting a first material to a heating period; and
after the subjecting, cooling the heated first material to form a structure with a controlled microstructure,
wherein at least a portion of the formed structure is in a glass phase, or
the formed structure comprises a polycrystalline ceramic having crystal grains substantially aligned with respect to a common direction.

Clause 56. The method of any clause or example herein, in particular, Clause 55, wherein the structure is formed as a solid-state ion-conducting layer.

Clause 57. The method of any clause or example herein, in particular, any one of Clauses 55-56, wherein the subjecting to the heating period comprises exposing the first material to a sintering temperature greater than a melting temperature of the first material for a duration less than 5 minutes.

Clause 58. The method of any clause or example herein, in particular, Clause 57, wherein the duration of the heating period is less than or equal to 60 seconds.

Clause 59. The method of any clause or example herein, in particular, any one of Clauses 57-58, wherein the duration of the heating period is in a range of 5-20 seconds, inclusive.

Clause 60. The method of any clause or example herein, in particular, any one of Clauses 55-59, wherein, after the cooling, an entirety of the formed structure has a single chemical composition and is in the glass phase.

Clause 61. The method of any clause or example herein, in particular, Clause 60, wherein the sintering temperature is more than 100° C. greater than the melting temperature, and the cooling comprises immersion of the heated first material in a liquid.

Clause 62. The method of any clause or example herein, in particular, any one of Clauses 60-61, wherein the sintering temperature is about 200° C. greater than the melting temperature.

Clause 63. The method of any clause or example herein, in particular, any one of Clauses 60-62, wherein the liquid comprises an oil.

Clause 64. The method of any clause or example herein, in particular, any one of Clauses 60-63, wherein an initial cooling rate of the cooling is at least 10³° C./s.

Clause 65. The method of any clause or example herein, in particular, any one of Clauses 55-59, wherein, after the cooling, the formed structure comprises one or more crystalline islands within the glass phase, and each portion of the formed structure has a same chemical composition.

Clause 66. The method of any clause or example herein, in particular, Clause 65, wherein the sintering temperature is in a range of 50° C. greater than the melting temperature and 100° C. greater than the melting temperature, inclusive, and the cooling comprises directing a gas flow at the heated first material.

Clause 67. The method of any clause or example herein, in particular, any one of Clauses 55-59, wherein, after the cooling, the formed structure comprises a polycrystalline layer disposed between a pair of glass phase layers, and each portion of the polycrystalline layer and the pair of glass phase layers has a same chemical composition.

Clause 68. The method of any clause or example herein, in particular, Clause 67, wherein the sintering temperature is less than 50° C. greater than the melting temperature, and the cooling comprises directing a gas flow at the heated first material.

Clause 69. The method of any clause or example herein, in particular, any one of Clauses 55-59, wherein, after the cooling, the formed structure comprises a glass phase layer atop a polycrystalline layer, and each portion of the glass phase layer and the polycrystalline layer has a same chemical composition.

Clause 70. The method of any clause or example herein, in particular, Clause 69, wherein the sintering temperature is less than 50° C. greater than the melting temperature and is asymmetrically applied with respect to a thickness of the first material, and the cooling comprises directing a gas flow at the heated first material.

Clause 71. The method of any clause or example herein, in particular, any one of Clauses 66-70, wherein the gas flow comprises an inert gas.

Clause 72. The method of any clause or example herein, in particular, any one of Clauses 66-71, wherein an initial cooling rate of the cooling is less than 0.5×10³ ° C./s.

Clause 73. The method of any clause or example herein, in particular, Clause 55, wherein the subjecting to the heating period generates a thermal gradient across a thickness of the first material.

Clause 74. The method of any clause or example herein, in particular, Clause 73, wherein, during the heating period, the first material is subjected to a maximum temperature less than a melting temperature of the first material.

Clause 75. The method of any clause or example herein, in particular, any one of Clauses 73-74, wherein the thermal gradient during the heating period is such that a temperature at a first end of the first material is 50-100° C., inclusive, less than the melting temperature of the first material and such that a temperature at a second end of the first material opposite the first end is 150-250° C., inclusive, less than the melting temperature of the first material.

Clause 76. The method of any clause or example herein, in particular, any one of Clauses 73-75, wherein the crystal grains of the polycrystalline ceramic are aligned with respect to a thickness of the formed structure.

Clause 77. The method of any clause or example herein, in particular, any one of Clauses 73-76, wherein the crystal grains of the polycrystalline ceramic are needle-like in shape.

Clause 78. The method of any clause or example herein, in particular, any one of Clauses 73-77, wherein ion conducting planes are along long ends of the crystal grains of the polycrystalline ceramic.

Clause 79. The method of any clause or example herein, in particular, any one of Clauses 55 and 73-78, wherein the subjecting to the heating period comprises:
passing a first electric current through a first Joule heating element disposed on a first side of the first material; and
passing a second electric current through a second Joule heating element disposed on a second side of the first material opposite the first side.

Clause 80. The method of any clause or example herein, in particular, Clause 79, wherein:
a magnitude of the first electric current is different than that of the second electric current;
a power applied to the first Joule heating element is different than that applied to the second Joule heating element;
a size of the first Joule heating element is different than that of the second Joule heating element; or
any combination of the above.

Clause 81. The method of any clause or example herein, in particular, any one of Clauses 79-80, wherein the first and second electric currents do not pass through the first material.

Clause 82. The method of any clause or example herein, in particular, any one of Clauses 55-81, wherein:
the formed structure comprises a solid-state electrolyte; or
the formed structure comprises a cathode composite of (i) a positive electrode material and (ii) a non-oxide solid electrolyte or beta-alumina.

Clause 83. A cathode layer comprising a positive electrode material and one of: (i) a non-oxide solid electrolyte and (ii) beta-alumina, glassy sodium polyaluminate, or both beta-alumina and glassy sodium polyaluminate.

Clause 84. The cathode layer of any clause or example herein, in particular, Clause 83, further comprising carbon particles.

Clause 85. The cathode layer of any clause or example herein, in particular, Clause 84, wherein the carbon particles comprises carbon black.

Clause 86. The cathode layer of any clause or example herein, in particular, any one of Clauses 83-85, wherein the positive electrode material comprises lithium nickel manganese cobalt oxide (LiNiMnCoO₂) or nickel manganese cobalt (NMC).

Clause 87. The cathode layer of any clause or example herein, in particular, any one of Clauses 83-86, further comprising a non-Li-conductive porous support.

Clause 88. The cathode layer of any clause or example herein, in particular, Clause 87, wherein the non-Li-conductive porous support comprises niobium pentoxide (Nb₂O₅), yttria-stabilized zirconia (YSZ), or lanthanum strontium manganite (LSM).

Clause 89. The cathode layer of any clause or example herein, in particular, any one of Clauses 83-86, wherein the positive electrode material comprises a polymer cathode material.

Clause 90. The cathode layer of any clause or example herein, in particular, Clause 89, wherein the polymer cathode material comprises an organosulfur compound, a radical compound, a carbonyl compound, or an imine compound.

Clause 91. The cathode layer of any clause or example herein, in particular, any one of Clauses 83-90, wherein the non-oxide solid electrolyte is a non-oxide lithium ion conductor.

Clause 92. The cathode layer of any clause or example herein, in particular, Clause 91, wherein the non-oxide lithium ion conductor has a Young's modulus less than or equal to 50 GPa.

Clause 93. The cathode layer of any clause or example herein, in particular, any one of Clauses 91-92, wherein the non-oxide lithium ion conductor is a halide solid electrolyte or sulfide solid electrolyte.

Clause 94. The cathode layer of any clause or example herein, in particular, Clause 93, wherein:
the halide solid electrolyte comprises (a) Li₂S—P₂S₅—LiX, where X is one or more of F, Cl, Br, I, At, and Ts, (b) Li₃MCl₆, where M is one or more of Y, In, Sc and Ho, (c) Li₃OX, where X is one or more of F, Cl, Br, I, At, and Ts, and/or (d) LiₓTa_{y}La_{z}Cl₃, where x, y, and z are numbers; or
the sulfide solid electrolyte comprises (a) Li₂S—P₂S₅ (LPS), (b) Li₁₀GeP₂S₁₂ (LGPS), (c) Li₁₀SnP₂S₁₂, and/or (d) Li₁₀SiP₂S₁₂.

Clause 95. The cathode layer of any clause or example herein, in particular, any one of Clauses 91-92, wherein the non-oxide lithium ion conductor is a NASICON-type electrolyte. Clause 96. The cathode layer of any clause or example herein, in particular, Clause 95, wherein the NASICON-type electrolyte comprises (a) Li_{1.5}Al_{0.5}Ti_{1.5}(PO₄)₃ (LATP); (b) Li₁₊ₓAlₓGe₂₋ₓ(PO₄)₃ (LAGP); or (c) Li₁₄Zn(GeO₄)₄ (LISICON).

Clause 97. The cathode layer of any clause or example herein, in particular, any one of Clauses 83-96, wherein the positive electrode material comprises Na_{0.66}Ni_{0.33}Mn_{0.67}O₂ (NNM), sodium vanadium phosphate (NVP), or NaMnFeNiO.

Clause 98. The cathode layer of any clause or example herein, in particular, any one of Clauses 83-86, further comprising a non-Na-conductive porous support.

Clause 99. The cathode layer of any clause or example herein, in particular, Clause 98, wherein the non-Na-conductive porous support comprises yttria-stabilized zirconia (YSZ).

Clause 100. The cathode layer of any clause or example herein, in particular, any one of Clauses 83-86, wherein the positive electrode material further comprises a polymer cathode material.

Clause 101. The cathode layer of any clause or example herein, in particular, Clause 100, wherein the polymer cathode material comprises an organosulfur compound or an imine compound.

Clause 102. The cathode layer of any clause or example herein, in particular, any one of Clauses 83-86, wherein the non-oxide solid electrolyte is a non-oxide sodium ion conductor.

Clause 103. The cathode layer of any clause or example herein, in particular, Clause 102, wherein the non-oxide sodium ion conductor has a Young's modulus less than or equal to 50 GPa.

Clause 104. The cathode layer of any clause or example herein, in particular, any one of Clauses 102-103, wherein the non-oxide sodium ion conductor is a halide solid electrolyte or sulfide solid electrolyte.

Clause 105. The cathode layer of any clause or example herein, in particular, Clause 104, wherein:
the halide solid electrolyte comprises (a) Na₂S—P₂S₅—NaX, where X is one or more of F, Cl, Br, I, At, and Ts, (b) Na₃OX, where X is one or more of F, Cl, Br, I, At, and Ts, and/or (c) Na—Y—Zr—Cl; or
the sulfide solid electrolyte comprises (a) Na₃PS₄; (b) Na₃SbS₄; (c) Na₃PSe₄; (d) Na₁₁Sn₂PS₁₂; (e) Na₁₁Sn₂SbS₁₂; (f) Na₃P_{0.62}As_{0.38}S₄, and/or (g) Na—P—S—Cl.

Clause 106. The cathode layer of any clause or example herein, in particular, any one of Clauses 102-103, wherein the non-oxide sodium ion conductor is a NASICON electrolyte.

Clause 107. The cathode layer of any clause or example herein, in particular, any one of Clauses 102-106, wherein the positive electrode material comprises a polymer electrolyte.

Clause 108. The cathode layer of any clause or example herein, in particular, Clause 107, wherein the polymer electrolyte comprises polyethylene oxide (PEO) and one of NaClO₄ and NaPF₆.

### Conclusion

Any of the features illustrated or described herein, for example, with respect to FIGS. 1A-17C or Clauses 1-108, can be combined with any other feature illustrated or described herein, for example, with respect to FIGS. 1A-17C or Clauses 1-108, to provide materials, systems, devices, structures, methods, or embodiments not otherwise illustrated or specifically described herein. All features described herein are independent of one another and, except where structurally impossible, can be used in combination with any other feature described herein. In view of the many possible embodiments to which the principles of the disclosed technology may be applied, it should be recognized that the illustrated embodiments are only examples and should not be taken as limiting the scope of the disclosed technology. Rather, the scope is defined by the following claims. We therefore claim all that comes within the scope and spirit of these claims.

1. A structure comprising:
a solid-state ion-conducting layer,
wherein at least a portion of the solid-state ion-conducting layer is in a glass phase, or
the solid-state ion-conducting layer comprises a polycrystalline ceramic having crystal grains substantially aligned with respect to a common direction.

2. The structure of claim 1, wherein an entirety of the solid-state ion-conducting layer has a single chemical composition and is in the glass phase.

3. The structure of claim 1, wherein:
the solid-state ion-conducting layer comprises one or more crystalline portions embedded within and surrounded by the glass phase; and
each portion of the solid-state ion-conducting layer has a same chemical composition.

4. The structure of claim 1, wherein:
the solid-state ion-conducting layer comprises a first sublayer in the glass phase, a second sublayer in the glass phase, and a polycrystalline sublayer between the first and second sublayers; and
each portion of the first sublayer, the second sublayer, and the polycrystalline sublayer has a same chemical composition.

5. (canceled)

6. The structure of claim 1, wherein:
the solid-state ion-conducting layer comprises a glass-phase sublayer and a polycrystalline sublayer adjacent to the glass-phase sublayer; and
each portion of the glass-phase sublayer and the polycrystalline sublayer has a same chemical composition.

7-12. (canceled)

13. The structure of claim 1, wherein the crystal grains of the polycrystalline ceramic are needle-like in shape.

14. (canceled)

15. A battery comprising:
a cathode; and
a solid-state electrolyte coupled to the cathode, the solid-state electrolyte comprising a solid-state ion-conducting layer,
wherein at least a portion of the solid-state ion-conducting layer is in a glass phase, or
the solid-state ion-conducting layer comprises a polycrystalline ceramic having crystal grains substantially aligned with respect to a common direction.

16. The battery of claim 15, further comprising an anode coupled to the solid-state electrolyte and disposed on a side of the solid-state electrolyte opposite from the cathode.

17-54. (canceled)

55. A method comprising:
subjecting a first material to a heating period; and
after the subjecting, cooling the heated first material to form a structure with a controlled microstructure,
wherein at least a portion of the formed structure is in a glass phase, or
the formed structure comprises a polycrystalline ceramic having crystal grains substantially aligned with respect to a common direction.

56. (canceled)

57. The method of claim 55, wherein the subjecting to the heating period comprises exposing the first material to a sintering temperature greater than a melting temperature of the first material for a duration less than 5 minutes.

58-60. (canceled)

61. The method of claim 57, wherein:
after the cooling, an entirety of the formed structure has a single chemical composition and is in the glass phase;
the sintering temperature is more than 100° C. greater than the melting temperature; and
the cooling comprises immersion of the heated first material in a liquid.

62-64. (canceled)

65. The method of claim 57, wherein, after the cooling, the formed structure comprises one or more crystalline islands within the glass phase, and each portion of the formed structure has a same chemical composition.

66. The method of claim 65, wherein:
the sintering temperature is in a range of 50° C. greater than the melting temperature and 100° C. greater than the melting temperature, inclusive; and
the cooling comprises directing a gas flow at the heated first material.

67. The method of claim 57, wherein:
after the cooling, the formed structure comprises a polycrystalline layer disposed between a pair of glass phase layers; and
each portion of the polycrystalline layer and the pair of glass phase layers has a same chemical composition.

68. The method of claim 67, wherein:
the sintering temperature is less than 50° C. greater than the melting temperature; and
the cooling comprises directing a gas flow at the heated first material.

69. The method of claim 57, wherein:
after the cooling, the formed structure comprises a glass phase layer atop a polycrystalline layer; and
each portion of the glass phase layer and the polycrystalline layer has a same chemical composition.

70. The method of claim 69, wherein:
the sintering temperature is less than 50° C. greater than the melting temperature and is asymmetrically applied with respect to a thickness of the first material; and
the cooling comprises directing a gas flow at the heated first material.

71-72. (canceled)

73. The method of claim 55, wherein the subjecting to the heating period generates a thermal gradient across a thickness of the first material.

74-78. (canceled)

79. The method of claim 55, wherein the subjecting to the heating period comprises:
passing a first electric current through a first Joule heating element disposed on a first side of the first material; and
passing a second electric current through a second Joule heating element disposed on a second side of the first material opposite the first side, and
wherein:
a magnitude of the first electric current is different than that of the second electric current;
a power applied to the first Joule heating element is different than that applied to the second Joule heating element;
a size of the first Joule heating element is different than that of the second Joule heating element; or
any combination of the above.

80-81. (canceled)

82. The method of claim 55, wherein:
the formed structure comprises a solid-state electrolyte; or
the formed structure comprises a cathode composite of (i) a positive electrode material and (ii) a non-oxide solid electrolyte or beta-alumina.

83-108. (canceled)
